(19) United States
(12) Patent Application Publication
(10) Pub. No.: US 2011/0072892 A1
(43) Pub. Date: Mar. 31, 2011

(54) H-FABP AS A MARKER FOR MYOCARDIAL HIBERNATION

(76) Inventors: Georg Hess, Mainz (DE); Andrea Horsch, Mannheim (DE); Dietmar Zdunek, Tutzing (DE)

(21) Appl. No.: 12/963,122

(22) Filed: Dec. 8, 2010

Related U.S. Application Data
(63) Continuation of application No. PCT/EP2009/057197, filed on Jun. 10, 2009.

(30) Foreign Application Priority Data
Jun. 10, 2008 (EP) 08157948.4

(51) Int. Cl. G01N 1/10

(52) U.S. Cl. 73/64.56

(57) ABSTRACT

The present invention relates to the use of H-FABP as a marker for myocardial hibernation. Also envisaged by the present invention is the use of H-FABP and a cardiac troponin for differentiating between myocardial necrosis and myocardial hibernation. The present invention also relates to a method for diagnosing myocardial hibernation in a subject based on determining the amount of heart fatty acid binding protein (H-FABP) in a sample of the subject and comparing the thus determined amount to a suitable reference amount. The method further, preferably, furthers comprises comparing the amount of a cardiac troponin in the sample, and comparing the, thus, determined amount to a reference for the cardiac troponin.

### RELATED APPLICATIONS

This application is a continuation of PCT/EP2009/057197 filed Jun. 10, 2009 and claims priority to EP 08157948.4 filed Jun. 10, 2008.

### FIELD OF THE INVENTION

The present invention relates to the use of H-FABP as a marker for myocardial hibernation. Also envisaged by the present invention is the use of H-FABP and a cardiac troponin for differentiating between myocardial necrosis and myocardial hibernation. The present invention also relates to a method for diagnosing myocardial hibernation in a subject based on determining the amount of heart fatty acid binding protein (H-FABP) in a sample of said subject and comparing the thus determined amount to a suitable reference amount. Said method further, preferably, furthers comprises comparing the amount of a cardiac troponin in said sample, and comparing the, thus, determined amount to a reference for said cardiac troponin. Also envisaged by the present invention is a method for differentiating between (i) myocardial hibernation, (ii) myocardial necrosis, (iii) myocardial hibernation accompanied by myocardial necrosis, and (iv) neither myocardial hibernation nor myocardial necrosis. Moreover, the present invention relates a method for identifying a subject being susceptible to a cardiac intervention and a method for predicting the success of a cardiac intervention, based on determining the amount of H-FABP and/or a cardiac troponin. Furthermore, the present invention relates to a method for diagnosing a cardiac complication caused by a cardiac intervention. Also encompassed by the present invention are kits and devices for carrying out the said methods.

### BACKGROUND

Myocardial hibernation is a condition in which myocardial contractility, metabolism and ventricular function are reduced in order to cope with a reduced oxygen supply. It is a chronic, but reversible cardiac dysfunction that is caused by prolonged myocardial hypoperfusion and that persists at least until blood flow is restored. Thus, hibernating myocardial cells are temporarily asleep, but still viable, and can wake up to normal function when the blood supply is fully restored by revascularization.

The detection of myocardial hibernation in suffering from coronary artery disease is important since myocardial hibernation is generally reversible, upon revascularization.

Therefore, there is growing evidence that the detection of myocardial hibernation in subjects with coronary artery disease not only identifies those individuals in which the improvement of cardiac function is likely, but also identifies high-risk individuals for which revascularization would significantly increase survival.

The detection of hibernating myocardial tissue, however, is difficult.

Hibernating myocardium may be detected by low dose dobutamine echocardiographic imaging that allows detecting the so called contractile reserve. The contractile reserve of hibernating myocardium is the capability to exhibit contractility to a suitable stimulus resulting in improvement of the global ejection fraction. Whereas dysfunctional but still viable muscle tissue can be stimulated by administration of dobutamine, necrotic tissue can not be stimulated.

In various studies, Positron-emission tomography had the highest predictive accuracy for detecting hibernating myocardium. Therefore, positron-emission tomography (abbreviated PET) is often used to identify those patients that would benefit from revascularization procedures. PET comprises two steps. In a first step a blood flow scan of the heart is obtained in order to identify underperfused myocardium tissue. Then, in a second step a second scan is made using ¹³N-ammonia and ¹⁸F-deoxyglucose in order to assess and glucose uptake. Non-viable cells and scar tissue do not take up glucose. Hibernating myocardium, however, accumulates glucose to the corresponding tissue perfusion. Positron emission tomography, despite being the most accurate technique available in detecting hibernating myocardium, has the disadvantage that it is very expensive and can be carried out only by specially trained personnel in only a few centers.

Hibernating myocardium can also be detected by MRI. MRI, however, also requires specific equipment and trained personnel.

Percutaneous coronary intervention is the most common technique for myocardial revascularization, and stents are currently used in more than 70% of these procedures. Although many randomized clinical trials have shown that complications such as vessel damage and embolization caused by percutaneous coronary interventions occur very rarely, data illustrating the clinical practice are less encouraging. According to recent publications, the incidence of acute myocardial infarction was around 3%, of urgent surgery (such as Coronary artery bypass surgery) around 1.5%, and of death around 2%.

Thus, cardiac interventions such as coronary cathetherization and stent implantation (which includes cathetherization) may cause cardiac complications such as myocardial damage.

Coronary catheterization typically involves the introducing of a catheter into blood vessels belonging to the heart, particularly into the coronary arteries. The catheter is a long, thin, flexible tube. Examples for coronary catheterization include coronary angiography as well as percutaneous coronary intervention (PCI). In coronary angiography the catheter is typically used to introduce a contrast agent and then a picture (e.g. an X-ray picture or magnetic resonance picture) is taken to visualize the inner opening e.g. of the coronary arteries. In PCI, an angioplasty or stent implantation is performed by means of the catheter. A stent is typically a prosthesis which is capable of keeping a blood vessel open by mechanical strain against the wall of the vessel, particularly by expanding against the wall of the vessel. Thus, a stent can prevent a vessel from closing and thus prevent e.g. myocardial infarction. Prior to deployment, a stent is collapsed into a small diameter (e.g. as a folding grille) and is expanded at the position of interest.

Though coronary catheterization has become an important tool in diagnostics and therapy, it has been found that the procedure itself is associated with a relevant risk and may cause cardiac complications such as myocardial damage. This may be due e.g. to interruption of the normal blood flow during the procedure (e.g. side-branch occlusion) or due to damage to the wall of a blood vessel, e.g. by the catheter itself or by a stent which injures the wall of the vessel into which it is inserted. In fact, it has been described that more than 40 percent of patients undergoing coronary angioplasty have evidence of minor degrees of myocardial damage as evidenced by release of cardiac troponin T (cTnT), which is considered to be marker of myocardial necrosis (Abbas, S. A., Glazier, J. J., Wu, A. H., Dupont, C. et al. (1996). Factors associated with the release of cardiac troponin T following percutaneous transluminal coronary angioplasty. Clin. Cardiol., vol. 19, pp. 782-786). Slightly lower numbers, apparently based on clinical evidence of complications, are reported in the table 18-3, table 52-2, and table 52-3 of the textbook Braunwald's Heart Disease—A textbook of cardiovascular medicine (Braunwald (ed.) (2005)).

It seems that procedure-related myocardial injury does not always become clinically apparent. This is particularly troublesome as myocytes (the muscle cells which make up the heart muscle or myocard) are generally not capable of regenerating so that even minor myocardial injury should be avoided. Ricciardi et al. report that contrast-enhanced magnetic resonance imaging (MRI) provides an anatomical correlate to biochemical evidence of procedure-related myocardial injury, despite the lack of ECG changes or wall motion abnormalities (Ricciardi, M. J., Wu, E., Davidson, C. J., Choi, K. M. (2001). Visualization of discrete microinfarction after percutaneous coronary intervention associated with mild creatine kinase-MB elevation. Circulation, vol. 103, pp. 2780-2783). The same authors report that mild elevation of creatine kinase-MB (CK-MB) after PCI is the result of discrete microinfarction.

However, as set forth MRI is a costly technique requiring expensive equipment, which is not routinely available to monitor patients after cardiac interventions. Furthermore, creatine kinase-MB (CK-MB) is considered to be a marker indicating the presence of necrosis. Thus, CK-MB may indicate cardiac complications only after some possibly irreversible damage has already occurred.

Similarly, Saadeddin investigated cardiac troponin I (cTnI), cardiac troponin T (cTnT), and CK-MB after apparently successful percutaneous transluminal coronary angioplasty (PTCA) (Saadeddin, S. M., Habbab, M. A., Sobki, S. H., Ferns, G. A. (2000) Detection of minor myocardial injury after successful percutaneous transluminal coronary angioplasty with or without stenting. Med Sci Monit, vol. 6, pp. 708-712). They report that cTnI was a very sensitive marker in detecting myocardial injury after coronary angioplasty with or without stenting. However, also cTnI is considered to be a marker indicating the presence of necrosis. Thus, cTnI may indicate cardiac complications only after some possibly irreversible damage has already occurred.

In the already mentioned study, Abbas et al. have described that high-risk coronary lesions and both minor and major complications of angioplasty are associated with cTnT release (Abbas, S. A., Glazier, M., Wu, A. H., Dupont, C. et al. (1996). Factors associated with the release of cardiac troponin T following percutaneous transluminal coronary angioplasty. Clin. Cardiol., vol. 19, pp. 782-786). However, also cTnT is considered to be marker of myocardial necrosis and thus may indicates cardiac complications only after some possibly irreversible damage has already occurred.

Recently, Heart-type fatty acid binding protein (H-FABP) was suggested as an early marker of myocardial infarction. Heart-type fatty acid-binding protein (H-FABP) is a low molecular weight cytoplasmic protein and present abundantly in the myocardium. When the myocardium is injured, as in the case of myocardial infarction, low molecular weight cytoplasmic proteins including H-FABP are released into the circulation and an elevated H-FABP level is detectable in a blood sample. (e.g. Okamoto et al., Clin Chem Lab Med 38(3):231-8 (2000) Human heart-type cytoplasmic fatty acid-binding protein (H-FABP) for the diagnosis of acute myocardial infarction. Clinical evaluation of H-FABP in comparison with myoglobin and creatine kinase isoenzyme MB; O'Donoghue et al., Circulation, 114; 550-557 (2006) Prognostic Utility of Heart-Type Fatty Acid Binding Protein in patients with acute coronary syndrome or Ruzgar et al., Heart Vessels, 21; 209-314 (2006) The use of human heart-type fatty acid-binding protein as an early diagnostic marker of myocardial necrosis in patients with acute coronary syndrome, and its comparison with troponin-T and its creatine kinase-myocardial band). Thus, H-FABP has been proposed as a marker for necrosis.

There is a need to improve diagnosing cardiac complications caused by cardiac interventions (such as stent implantation) and to overcome the disadvantages of the state of the art. In particular, there is a need to provide further and improved diagnostic means and methods for diagnosing cardiac complications due to a cardiac intervention. More particularly, there is a need to provide further means and methods which allow diagnosis of cardiac complications independent of myocardial necrosis or even before myocardial necrosis takes place.

Moreover, biomarkers which would allow for a reliable detection of hibernating tissue are not yet reported but are nevertheless highly desirable. Also, biomarkers for determining the success of a cardiac intervention as well as for identifying a subject being susceptible to a cardiac intervention are highly desirable.

Therefore, there is a clear need for diagnostic and prognostic means and methods allowing an easy, reliable and quick diagnosis of myocardial hibernation in a subject. The said means and methods shall allow a diagnosis of said subject and shall allow identifying a subject being susceptible to cardiac intervention, an appropriate treatment of said subject, an easy and reliable risk analysis, and shall avoid the drawbacks of the current techniques as laid out above.

Thus, the technical problem underlying the present invention must be seen as the provision of means and methods for complying with the aforementioned needs.

The technical problem is solved by the embodiments characterized in the claims and herein below.

### SUMMARY OF THE INVENTION

Accordingly, the present invention relates to a method for diagnosing myocardial hibernation in a subject, which, preferably, suffers from stable coronary artery disease, comprising the steps
a) determining the amount of heart type fatty acid binding protein (H-FABP) in a sample of said subject, and
b) comparing the amount of H-FABP as determined in step a) to a reference amount, and
c) diagnosing myocardial hibernation.

The method of the present invention, preferably, is an in vitro method. Moreover, it may comprise steps in addition to those explicitly mentioned above. For example, further steps may relate to sample pre-treatments or evaluation of the results obtained by the method. The method of the present invention may be also used for monitoring, confirmation, and subclassification of a subject as described herein with respect to myocardial hibernation. The method may be carried out manually or assisted by automation. Preferably, step (a), (b) and/or (c) may in total or in part be assisted by automation, e.g., by a suitable robotic and sensory equipment for the determination in step (a) or a computer-implemented comparison in step (h).

### DETAILED DESCRIPTION OF THE INVENTION

The term “diagnosing” with respect to myocardial hibernation as used herein refers to assessing whether a subject suffers from myocardial hibernation, and, thus, to assess whether the mycocardium of said subject comprises hibernating tissue. Accordingly, the method referred to above, preferably, is also a method for detecting hibernating myocardial tissue (and, thus, for identifying a subject whose myocardium comprises hibernating tissue). Thus, the terms “diagnosing myocardial hibernation” and “detecting hibernating myocardial tissue” may be used interchangeably herein.

As will be understood by those skilled in the art, such the aforementioned assessment is usually not intended to be correct for all (i.e. 100%) of the subjects. The term, however, requires that a statistically significant portion of subjects can be identified (e.g. a cohort in a cohort study). Whether a portion is statistically significant can be determined without further ado by the person skilled in the art using various well known statistic evaluation tools, e.g., determination of confidence intervals, p-value determination, Student's t-test, Mann-Whitney test etc. Details are found in Dowdy and Wearden, Statistics for Research, John Wiley & Sons, New York 1983. Preferred confidence intervals are at least 90%, at least 95%, at least 97%, at least 98% or at least 99%. The p-values are, preferably, 0.1, 0.05, 0.01, 0.005, or 0.0001. More preferably, at least 60%, at least 70%, at least 80% or at least 90% of the subjects of a population can be properly identified by the method of the present invention.

Diagnosing according to the present invention includes monitoring, confirmation, subclassification and prediction of the relevant condition, symptoms or risks therefor. Monitoring relates to keeping track of an already diagnosed disease. Confirmation relates to the strengthening or substantiating a diagnosis already performed using other indicators or markers. Subclassification relates to further defining a diagnosis according to different subclasses of the diagnosed disorder, e.g. defining according to mild and severe forms of the condition or disorder.

The myocardium, preferably, is the middle layer of the heart wall that comprises cardiac muscle. Myocardial hibernation, preferably, is a persistent myocardial dysfunction that occurs when myocardial perfusion is chronically reduced but sufficient to maintain the viability of the myocardial tissue (see e.g. Braunwald's Heart Disease 7th Ed. 2005 Elsevier Publishers, Chapters 23 and 50). Thus, myocardial hibernation, preferably, is a pathophysiological condition, in which myocardial regions (a region) show (s) a chronically depressed contractile ability, but are still viable. It is known in the art that myocardial hibernation can cause abnormal systolic or diastolic ventricular function or both. Moreover, the skilled person knows that myocardial hibernation is a state of persistent ventricular dysfunction that can be reversed by revascularization. Accordingly, the term “hibernating myocardium” as used herein, preferably, relates to viable myocardial tissue with chronic reversible contractile dysfunction, which can be improved upon revascularization. Preferably, the term “myocardial hibernation” does not include myocardial stunning which is a transient postischemic dysfunction. However, it is known the art that stunning myocardium and hibernating myocardium can coexist and that stunning myocardium may turn into hibernating myocardium, particularly in cases of repetitively stunned tissues. Reviews on myocardial hibernation are, e.g., given by Heusch et al. (Am J Physiol Heart Circ Physiol 288:984-999, 2005) and Kalra et al. (Kalra D K, Zoghbi W A: Myocardial hibernation in coronary artery disease. Curr Atheroscler Rep 2002, 4:149-155). The existence of hibernating myocardium was first shown in subjects after bypass surgery. Angiographic studies in subjects which underwent coronary angioplasty, e.g., revealed immediate recovery of global and regional systolic, as well as diastolic, function after revascularization. It has been proposed that the formation of hibernating myocardium is due to chronic ischemia and is a mechanism to prevent, myocardial necrosis and other ischemic symptoms. The exact molecular mechanisms underlying hibernation are still not completely understood, however they may include impaired calcium metabolism by the sarcoplasmic reticulum and reduced sensitivity of myofibrils to calcium. Taken together, the aforementioned methods allows to detect viable, but dysfunctional myocardial tissue.

The term “subjects” as used herein relates to animals, preferably mammals, and, more preferably, humans. Preferably, the subject referred to in accordance with the aforementioned method suffers from coronary artery disease, and more preferably, from stable coronary artery disease. Moreover, the subject may exhibit the symptoms accompanied therewith, i.e. being at least suspected to suffer from said disease. The term “coronary artery disease”, abbreviated CAD, frequently also called coronary heart disease (CHD) or atherosclerotic heart disease, is known to the person skilled in the art. Preferably, the term refers to a condition in which the blood vessels that supply blood and oxygen to the heart are narrowed. Coronary artery disease is usually caused by a condition called atherosclerosis, which occurs when fatty material and a substance called plaque builds up on the walls of your arteries. This causes them to get narrow. Particularly, CAD is the result of the accumulation of atheromatous plaques within the walls of the arteries that supply the myocardium (the muscle of the heart). Preferably, a subject with stable CAD has at least 50% stenosis (and thus at least 50% occlusion), in at least one major coronary artery. How to assess the degree of occlusion of a coronary artery is well known in the art, preferably, the degree is assessed by coronary angiography. While the symptoms and signs of coronary artery disease are noted in the advanced state of disease, most individuals with coronary artery disease show no evidence of disease for decades as the disease progresses before the first onset of symptoms of an acute event, often a “sudden” heart attack, finally arise.

As mentioned above, the subject in the context of the present invention, preferably, shall suffer from stable coronary artery disease. The term “stable” in this context means that a subject who suffers from CAD does not suffer from an acute cardiovascular syndrome (ACS). More particularly, stable CAD does not include STEMI (ST-elevation myocardial infarction); NSTEMI (non ST-elevation myocardial infarction) and unstable angina pectoris. Preferably, the subject shall have a cardiac troponin level, preferably, a troponin T level lower than, 0.25 ng/ml, and more preferably, lower than 0.1 ng/ml in a blood, blood serum or blood plasma sample (which indicates that said subject does not suffer from ACS). However, the subject may have or may not have a history of events belonging to the acute cardiovascular syndrome, i.e. the subject may have or may not have exhibited one acute cardiovascular event in the past. Acute cardiovascular events are, preferably, acute coronary syndromes (ACS). ACS patients can show unstable angina pectoris (UAP) or myocardial infarction (MI). MI can be an ST-elevation MI (STEMI) or a non-ST-elevated MI (NSTEMI). The occurring of an ACS can be followed by a left ventricular dysfunction (LVD) and symptoms of heart failure. How to diagnose an acute cardiovascular event is well known in the art.

In case the subject has a history of at least one acute cardiovascular event, it is particularly contemplated that said subject shall not have exhibited an acute cardiovascular event recently, preferably not within one week, not within two weeks, one month, six month or one year prior to carrying out the method of the present invention more precisely: prior to obtaining the sample to be analyzed. Accordingly, the acute cardiovascular event has, preferably, occurred at least more than one week, one month, six month or one year prior to determining the various markers as specified herein (more precisely: prior to obtaining the sample to be analyzed). It is, particularly, contemplated that an acute cardiovascular event did not occur within one month prior to carrying out the method of the present invention.

Preferably, the subject shall be suspected to comprise hibernating tissue in the myocardium. An indicator for the presence of hibernating tissue, preferably, is coronary artery disease and/or abnormal systolic or diastolic ventricular function (particularly left ventricular function). The presence of hibernating myocardium, preferably, is to be assumed if the myocardium comprises regions of dysfunctional contractility. How to assess dysfunctional contractility of the myocardium is well known in the art. Preferably, dysfunctional contractility of the myocardium can be determined by echocardiography or MRT. The present invention is particular advantageous for subjects with regions of dysfunctional contractility in the myocardium, since the method of the present inventions allows to assess the reasons therefore, e.g. whether the dysfunctional contractility is due to necrosis (caused by non viable myocytes) or hibernation (caused by viable but dysfunctional myocytes).

Thus, the subject in the context of the methods of the present invention, preferably, suffers from stable coronary artery disease and/or (preferably and) comprises myocardial tissue with dysfunctional contractility. In one preferred embodiment, said subject is a subject whose myocardium was shown by echocardiography to comprise a region (regions) with dysfunctional contractility.

The term “sample” refers to a sample of a body fluid, to a sample of separated cells or to a sample from a tissue or an organ. Samples of body fluids can be obtained by well known techniques and include, preferably, samples of blood, plasma, serum, or urine, more preferably, samples of blood, plasma or serum. Tissue or organ samples may be obtained from any tissue or organ by, e.g., biopsy. Particularly contemplated is a tissue sample of the heart, preferably of the myocardium with dysfunctional contractility that, preferably, is obtained by biopsy. Separated cells may be obtained from the body fluids or the tissues or organs by separating techniques such as centrifugation or cell sorting. Preferably, cell-, tissue- or organ samples are obtained from those cells, tissues or organs which express or produce the peptides referred to herein.

The term “H-FABP” as used herein refers to the heart fatty acid binding protein. Preferably, the term also includes variants of the heart type fatty acid binding protein. H-FABP is frequently also referred to heart type fatty acid binding protein. H-FABP is also known as FABP3. H-FABP is also as FABP3. H-FABP as used herein, preferably, relates to human H-FABP. The cDNA sequence as well the protein sequence of human H-FABP is well known in the art and was first described by Peeters et al. (Biochem. J. 276 (Pt 1), 203-207 (1991)). Moreover, the sequence of human H-FABP can be found, preferably, in Genebank entry U57623.1 (cDNA sequence) and AAB02555.1 (protein sequence). The major physiological of function of FABP is thought to be the transport of free fatty acids, see e.g. Storch et al., Biochem. Biophys. Acta. 1486 (2000), 28-44.

A variant as referred to in accordance with the present invention shall have an amino acid sequence which differs due to at least one amino acid substitution, deletion and/or addition wherein the amino acid sequence of the variant is still, preferably, at least 50%, 60%, 70%, 80%, 85%, 90%, 92%, 95%, 97%, 98%, or 99% identical with the amino sequence of H-FABP. Variants may be allelic variants, splice variants or any other species specific homologs, paralogs, or orthologs. Moreover, the variants referred to herein include fragments of the specific H-FABP or the aforementioned types of variants as long as these fragments have the essential immunological and biological properties as referred to above. Such fragments may be, e.g., degradation products of H-FABP. Further included are variants which differ due to posttranslational modifications such as phosphorylation or myristylation

The degree of identity between two amino acid sequences can be determined by algorithms well known in the art. Preferably, the degree of identity is to be determined by comparing two optimally aligned sequences over a comparison window, where the fragment of amino acid sequence in the comparison window may comprise additions or deletions (e.g., gaps or overhangs) as compared to the reference sequence (which does not comprise additions or deletions) for optimal alignment. The percentage is calculated by determining the number of positions at which the identical amino acid residue occurs in both sequences to yield the number of matched positions, dividing the number of matched positions by the total number of positions in the window of comparison and multiplying the result by 100 to yield the percentage of sequence identity. Optimal alignment of sequences for comparison may be conducted by the local homology algorithm of Smith and Waterman Add. APL. Math. 2:482 (1981), by the homology alignment algorithm of Needleman and Wunsch J. Mol. Biol. 48:443 (1970), by the search for similarity method of Pearson and Lipman Proc. Natl. Acad Sci. (USA) 85: 2444 (1988), by computerized implementations of these algorithms (GAP, BESTFIT, BLAST, PASTA, and TFASTA in the Wisconsin Genetics Software Package, Genetics Computer Group (GCG), 575 Science Dr., Madison, Wis.), or by visual inspection. Given that two sequences have been identified for comparison, GAP and BESTFIT are preferably employed to determine their optimal alignment and, thus, the degree of identity. Preferably, the default values of 5.00 for gap weight and 0.30 for gap weight length are used.

Determining the amount of the peptides or polypeptides referred to in this specification relates to measuring the amount or concentration, preferably semi-quantitatively or quantitatively. Also contemplated is the determination of variants of said peptides of and polypeptides. Measuring can be done directly or indirectly. Direct measuring relates to measuring the amount or concentration of the peptide or polypeptide based on a signal which is obtained from the peptide or polypeptide itself and the intensity of which directly correlates with the number of molecules of the peptide present in the sample. Such a signal—sometimes referred to herein as intensity signal—may be obtained, e.g., by measuring an intensity value of a specific physical or chemical property of the peptide or polypeptide. Indirect measuring includes measuring of a signal obtained from a secondary component (i.e. a component not being the peptide or polypeptide itself) or a biological read out system, e.g., measurable cellular responses, ligands, labels, or enzymatic reaction products.

In accordance with the present invention, determining the amount of a peptide or polypeptide can be achieved by all known means for determining the amount of a peptide in a sample. Said means comprise immunoassay devices and methods which may utilize labeled molecules in various sandwich, competition, or other assay formats. Said assays will develop a signal which is indicative for the presence or absence of the peptide or polypeptide. Moreover, the signal strength can, preferably, be correlated directly or indirectly (e.g. reverse-proportional) to the amount of polypeptide present in a sample. Further suitable methods comprise measuring a physical or chemical property specific for the peptide or polypeptide such as its precise molecular mass or NMR spectrum. Said methods comprise, preferably, biosensors, optical devices coupled to immunoassays, biochips, analytical devices such as mass-spectrometers, NMR-analyzers, or chromatography devices. Further, methods include micro-plate ELISA-based methods, fully-automated or robotic immunoassays (available for example on Elecsys™ analyzers), CBA (an enzymatic Cobalt Binding Assay, available for example on Roche-Hitachi™ analyzers), and latex agglutination assays (available for example on Roche-Hitachi™ analyzers).

Preferably, determining the amount of a peptide or polypeptide comprises the steps of (a) contacting a cell capable of eliciting a cellular response the intensity of which is indicative of the amount of the peptide or polypeptide with the said peptide or polypeptide for an adequate period of time, (b) measuring the cellular response. For measuring cellular responses, the sample or processed sample is, preferably, added to a cell culture and an internal or external cellular response is measured. The cellular response may include the measurable expression of a reporter gene or the secretion of a substance, e.g. a peptide, polypeptide, or a small molecule. The expression or substance shall generate an intensity signal which correlates to the amount of the peptide or polypeptide.

Also preferably, determining the amount of a peptide or polypeptide comprises the step of measuring a specific intensity signal obtainable from the peptide or polypeptide in the sample. As described above, such a signal may be the signal intensity observed at an m/z variable specific for the peptide or polypeptide observed in mass spectra or a NMR spectrum specific for the peptide or polypeptide.

Determining the amount of a peptide or polypeptide may, preferably, comprise the steps of (a) contacting the peptide with a specific ligand, (b) (optionally) removing non-bound ligand, (c) measuring the amount of bound ligand. The bound ligand will generate an intensity signal. Binding according to the present invention includes both covalent and non-covalent binding. A ligand according to the present invention can be any compound, e.g., a peptide, polypeptide, nucleic acid, or small molecule, binding to the peptide or polypeptide described herein. Preferred ligands include antibodies, nucleic acids, peptides or polypeptides such as receptors or binding partners for the peptide or polypeptide and fragments thereof comprising the binding domains for the peptides, and aptamers, e.g. nucleic acid or peptide aptamers. Methods to prepare such ligands are well-known in the art. For example, identification and production of suitable antibodies or aptamers is also offered by commercial suppliers. The person skilled in the art is familiar with methods to develop derivatives of such ligands with higher affinity or specificity. For example, random mutations can be introduced into the nucleic acids, peptides or polypeptides. These derivatives can then be tested for binding according to screening procedures known in the art, e.g. phage display. Antibodies as referred to herein include both polyclonal and monoclonal antibodies, as well as fragments thereof, such as Fv, Fab and F(ab)₂ fragments that are capable of binding antigen or hapten. The present invention also includes single chain antibodies and humanized hybrid antibodies wherein amino acid sequences of a non-human donor antibody exhibiting a desired antigen-specificity are combined with sequences of a human acceptor antibody. The donor sequences will usually include at least the antigen-binding amino acid residues of the donor but may comprise other structurally and/or functionally relevant amino acid residues of the donor antibody as well. Such hybrids can be prepared by several methods well known in the art. Preferably, the ligand or agent binds specifically to the peptide or polypeptide. Specific binding according to the present invention means that the ligand or agent should not bind substantially to (“cross-react” with) another peptide, polypeptide or substance present in the sample to be analyzed. Preferably, the specifically bound peptide or polypeptide should be bound with at least 3 times higher, more preferably at least 10 times higher and even more preferably at least 50 times higher affinity than any other relevant peptide or polypeptide. Non-specific binding may be tolerable, if it can still be distinguished and measured unequivocally, e.g. according to its size on a Western Blot, or by its relatively higher abundance in the sample. Binding of the ligand can be measured by any method known in the art. Preferably, said method is semi-quantitative or quantitative. Suitable methods are described in the following.

First, binding of a ligand may be measured directly, e.g. by NMR or surface plasmon resonance.

Second, if the ligand also serves as a substrate of an enzymatic activity of the peptide or polypeptide of interest, an enzymatic reaction product may be measured (e.g. the amount of a protease can be measured by measuring the amount of cleaved substrate, e.g. on a Western Blot). Alternatively, the ligand may exhibit enzymatic properties itself and the “ligand/peptide or polypeptide” complex or the ligand which was bound by the peptide or polypeptide, respectively, may be contacted with a suitable substrate allowing detection by the generation of an intensity signal. For measurement of enzymatic reaction products, preferably the amount of substrate is saturating. The substrate may also be labeled with a detectable label prior to the reaction. Preferably, the sample is contacted with the substrate for an adequate period of time. An adequate period of time refers to the time necessary for a detectable, preferably measurable, amount of product to be produced. Instead of measuring the amount of product, the time necessary for appearance of a given (e.g. detectable) amount of product can be measured.

Third, the ligand may be coupled covalently or non-covalently to a label allowing detection and measurement of the ligand. Labeling may be done by direct or indirect methods. Direct labeling involves coupling of the label directly (covalently or non-covalently) to the ligand. Indirect labeling involves binding (covalently or non-covalently) of a secondary ligand to the first ligand. The secondary ligand should specifically bind to the first ligand. Said secondary ligand may be coupled with a suitable label and/or be the target (receptor) of tertiary ligand binding to the secondary ligand. The use of secondary, tertiary or even higher order ligands is often used to increase the signal. Suitable secondary and higher order ligands may include antibodies, secondary antibodies, and the well-known streptavidin-biotin system (Vector Laboratories, Inc.). The ligand or substrate may also be “tagged” with one or more tags as known in the art. Such tags may then be targets for higher order ligands. Suitable tags include biotin, digoxygenin, His-Tag, Glutathion-S-Transferase, FLAG, GFP, myc-tag, influenza A virus haemagglutinin (HA), maltose binding protein, and the like. In the case of a peptide or polypeptide, the tag is preferably at the N-terminus and/or C-terminus. Suitable labels are any labels detectable by an appropriate detection method. Typical labels include gold particles, latex beads, acridan ester, luminol, ruthenium, enzymatically active labels, radioactive labels, magnetic labels (“e.g. magnetic heads”, including paramagnetic and superparamagnetic labels), and fluorescent labels. Enzymatically active labels include e.g. horseradish peroxidase, alkaline phosphatase, beta-Galactosidase, Luciferase, and derivatives thereof. Suitable substrates for detection include di-amino-benzidine (DAB), 3,3′-5,5′-tetramethylbenzidine, NBT-BLIP (4-nitro blue tetrazolium chloride and 5-bromo-4-chloro-3-indolyl-phosphate, available as ready-made stock solution from Roche Diagnostics), CDP-Star™ (Amersham Biosciences), ECF™ (Amersham Biosciences). A suitable enzyme-substrate combination may result in a colored reaction product, fluorescence or chemiluminescence, which can be measured according to methods known in the art (e.g. using a light-sensitive film or a suitable camera system). As for measuring the enzymatic reaction, the criteria given above apply analogously. Typical fluorescent labels include fluorescent proteins (such as GFP and its derivatives), Cy3, Cy5, Texas Red, Fluorescein, and the Alexa dyes (e.g. Alexa 568). Further fluorescent labels are available e.g. from Molecular Probes (Oregon). Also the use of quantum dots as fluorescent labels is contemplated. Typical radioactive labels include ³⁵S, ¹²⁵I, ³²P, ³³P and the like. A radioactive label can be detected by any method known and appropriate, e.g. a light-sensitive film or a phosphor imager. Suitable measurement methods according the present invention also include precipitation (particularly immunoprecipitation), electrochemiluminescence (electro-generated chemiluminescence), RIA (radioimmunoassay), ELISA (enzyme-linked immunosorbent assay), sandwich enzyme immune tests, electrochemiluminescence sandwich immunoassays (ECLIA), dissociation-enhanced lanthanide fluoro immuno assay (DELFIA), scintillation proximity assay (SPA), turbidimetry, nephelometry, latex-enhanced turbidimetry or nephelometry, or solid phase immune tests. Further methods known in the art (such as gel electrophoresis, 2D gel electrophoresis, SDS polyacrylamid gel electrophoresis (SDS-PAGE), Western Blotting, and mass spectrometry), can be used alone or in combination with labeling or other detection methods as described above.

The amount of a peptide or polypeptide may be, also preferably, determined as follows: (a) contacting a solid support comprising a ligand for the peptide or polypeptide as specified above with a sample comprising the peptide or polypeptide and (b) measuring the amount peptide or polypeptide which is bound to the support. The ligand, preferably chosen from the group consisting of nucleic acids, peptides, polypeptides, antibodies and aptamers, is preferably present on a solid support in immobilized form. Materials for manufacturing solid supports are well known in the art and include, inter alia, commercially available column materials, polystyrene beads, latex beads, magnetic beads, colloid metal particles, glass and/or silicon chips and surfaces, nitrocellulose strips, membranes, sheets, duracytes, wells and walls of reaction trays, plastic tubes etc. The ligand or agent may be bound to many different carriers. Examples of well-known carriers include glass, polystyrene, polyvinyl chloride, polypropylene, polyethylene, polycarbonate, dextran, nylon, amyloses, natural and modified celluloses, polyacrylamides, agaroses, and magnetite. The nature of the carrier can be either soluble or insoluble for the purposes of the invention. Suitable methods for fixing/immobilizing said ligand are well known and include, but are not limited to ionic, hydrophobic, covalent interactions and the like. It is also contemplated to use “suspension arrays” as arrays according to the present invention (Nolan 2002, Trends Biotechnol. 20(1):9-12). In such suspension arrays, the carrier, e.g. a microbead or microsphere, is present in suspension. The array consists of different microbeads or microspheres, possibly labeled, carrying different ligands. Methods of producing such arrays, for example based on solid-phase chemistry and photo-labile protective groups, are generally known (U.S. Pat. No. 5,744,305).

The term “amount” as used herein encompasses the absolute amount of a polypeptide or peptide, the relative amount or concentration of the said polypeptide or peptide as well as any value or parameter which correlates thereto or can be derived therefrom. Such values or parameters comprise intensity signal values from all specific physical or chemical properties obtained from the said peptides by direct measurements, e.g., intensity values in mass spectra or NMR spectra. Moreover, encompassed are all values or parameters which are obtained by indirect measurements specified elsewhere in this description, e.g., response levels determined from biological read out systems in response to the peptides or intensity signals obtained from specifically bound ligands. It is to be understood that values correlating to the aforementioned amounts or parameters can also be obtained by all standard mathematical operations.

The term “comparing” as used herein encompasses comparing the amount of the peptide or polypeptide comprised by the sample to be analyzed with an amount of a suitable reference source specified elsewhere in this description. It is to be understood that comparing as used herein refers to a comparison of corresponding parameters or values, e.g., an absolute amount is compared to an absolute reference amount while a concentration is compared to a reference concentration or an intensity signal obtained from a test sample is compared to the same type of intensity signal of a reference sample. The comparison referred to in step (b) of the method of the present invention may be carried out manually or computer assisted. For a computer assisted comparison, the value of the determined amount may be compared to values corresponding to suitable references which are stored in a database by a computer program. The computer program may further evaluate the result of the comparison, i.e. automatically provide the desired assessment in a suitable output format. Based on the comparison of the amount(s) determined in order to carry out the method of the present invention and the reference amount (s), it is possible to assess whether a subject as suffers from myocardial hibernation. Therefore, the reference amount is to be chosen so that either a difference or a similarity in the compared amounts allows diagnosis of myocardial hibernation and, thus, detection of hibernating myocardium.

Accordingly, the term “reference amounts” as used herein refers to amounts of the polypeptides which allow diagnosis of myocardial hibernation, and, thus, detection of hibernating myocardial tissue may either be derived from (i) a subject known to comprise hibernating myocardial tissue (or more preferably physiologically relevant amounts of hibernating tissue, see elsewhere herein) (ii) a subject known not to comprise hibernating myocardial tissue (or more preferably a subject known to comprise physiologically not significant amounts of hibernating myocardial tissue). Moreover, the reference amounts, preferably, define thresholds. Suitable reference amounts or threshold amounts may be determined by the method of the present invention from a reference sample to be analyzed together, i.e. simultaneously or subsequently, with the test sample. A preferred reference amount serving as a threshold may be derived from the upper limit of normal (ULN), i.e. the upper limit of the physiological amount to be found in a population of subjects (e.g. patients enrolled for a clinical trial). The ULN for a given population of subjects can be determined by various well known techniques. A suitable technique may be to determine the median of the population for the peptide or polypeptide amounts to be determined in the method of the present invention.

Accordingly, a reference amount defining a threshold amount for H-FABP as referred to in accordance with the present invention is 1500 pg/ml, 2000 pg/ml or 3000 pg/ml or, more preferably, 4000 pg/ml.

Preferably, an amount of H-FABP in a sample of a subject larger than the reference amount for H-FABP indicates that said subject suffers from myocardial hibernation, and, thus, that the myocardium of said subject comprises hibernating tissue. More preferably, an amount of H-FABP in a sample of a subject larger than the reference amount for H-FABP indicates that that the myocardium of said subject comprises physiologically significant amounts of hibernating tissue (see also elsewhere herein).

Preferably, an amount of H-FABP in a sample of a subject lower than the reference amount for H-FABP indicates that said subject does not suffer from myocardial hibernation, and, thus, that the myocardium of said subject, preferably, does not comprise hibernating myocardial tissue. More preferably, an amount of H-FABP in a sample of a subject lower than the reference amount for H-FABP indicates that the myocardium of said subject does not comprise physiologically significant amounts of hibernating tissue, and, thus, that the myocardium of said subject may comprise amounts of hibernating tissue that are, however, physiological not significant. Whether amounts of hibernating tissue are physiological significant or not can be determined by the skilled person (see also elsewhere herein).

As described herein, H-FABP is a valuable marker for hibernating myocardial tissue. Thus, it is to be understood that the amount of H-FABP is an indicator for the degree of myocardial hibernation. Thus, low amounts preferably indicate that there are, if at all, relatively low amounts of myocardial tissue affected by hibernation, whereas large amounts indicate hibernation. Generally, the larger the amount of H-FABP, the larger is the amount of hibernating tissue and, thus of tissue which is still viable (hut dysfunctional). Generally, the lower the amount of H-FABP, the lower is the amount of hibernating tissue and, thus of tissue which is still viable.

In the studies underlying the present invention, H-FABP was measured in samples of subjects having coronary artery disease (grouped in 1-, 2-, and 3-vessel disease) see Examples). It has been found in the study underlying the present invention that H-FABP is a biomarker for hibernating myocardial tissue and, thus, for myocardial tissue that is dysfunctional but still viable. This result was surprising since H-FABP has been described as a marker for necrosis and not for viable tissue (see e.g., See e.g, Figiel et al. (2008) Heart-type fatty acid binding protein—a reliable marker of myocardial necrosis in a heterogeneous group of patients with acute coronary syndrome without persistent ST elevation. Kardiol Pol.; 66(3):253-259, or Ruzgar et al., Heart Vessels, 21; 209-314 (2006) The use of human heart-type fatty acid-binding protein as an early diagnostic marker of myocardial necrosis in patients with acute coronary syndrome, and its comparison with troponin-T and its creatine kinase-myocardial band).

The method of the present invention will be, if applied, very beneficial since the method allows for and easy, reliable and inexpensive identification of a subject whose myocardium comprises a region (regions) of hibernating tissue. Reliable identification of those subjects is important, since it allows the initiation of an appropriate treatment: myocardial hibernation is generally reversible and left ventricular function can be improved upon revascularization. Moreover, revascularization prevents myocardial necrosis of the hibernating tissue sections. Without the method of the present invention, the presence of the hibernating tissue might remain undetected since other methods for the diagnosis of myocardial hibernation are cost-intensive and require specifically trained personnel and specific instruments. Moreover, the techniques of the prior can usually not be implemented in portable systems whereas the method of the present invention can be implemented even in portable assays, such as test stripes.

Taken together, the present invention allows a reliable identification of subjects suffering from myocardial hibernation. The method is advantageous since populations can be rapidly screened and subjects can be treated accordingly. If hibernation remains undetected, the affected tissue eventually will become necrotic which would put the patient at even higher risk.

Preferably, the method of the present invention further comprises determining the amount of a cardiac troponin in a sample of said subject and comparing the, thus determined amount to a reference amount for said cardiac troponin. Of course, the said cardiac troponin and H-FABP can be determined simultaneously, sequentially, or individually. Also contemplated is a determination in the same sample or different samples, i.e. more than one sample.

Cardiac troponins are markers for myocardial necrosis (see above). Accordingly, the additional determination of a cardiac troponin, preferably, allows diagnosing myocardial necrosis and, thus, assessing whether the myocardium of a subject comprises non viable tissue and, thus, whether said myocardium comprises necrotic tissue/death myocytes.

The term “myocardial necrosis” as used herein, preferably, refers to necrotic tissue in a part/parts of the myocardium and, thus, to non-viable myocardial tissue/myocytes. Preferably, the cell death occurs as a result of oxygen deprivation, which itself is caused by obstruction to the blood supply (ischemic necrosis). It is to be understood, that the affected cells, contrary to cells affected by hibernation, can not grow back, and thus are not viable anymore. A result of necrosis, preferably, is the loss of the cell membrane and the release of proteolytic enzymes that cause cellular disruption. Myocardial necrosis in the context of the present invention, preferably, is localized (e.g. due to myocardial infarction, or diffuse as in dilated cardiomyopathy, myocardial damage caused by cardiotoxic agents, or myocarditis). In it known in the art that necrotic cells are not functional and, thus, not contractile anymore, and therefore do not contribute to the pumping function of the heart. The function of necrotic cells can not be restored. It is to be understood that a subject who suffers from myocardial necrosis comprises necrotic, non viable tissue in his myocardium.

It is known in the art that a collagen scar may form in tissue affected by necrosis. A collagen scar is formed when myocardial tissue is replaced by connective tissue. Preferably, the terms “myocardial necrosis” or “necrotic tissue” in the context of the present invention do not encompass scarring/collagen scars and fibrotic tissue present in the myocardium.

The term “cardiac troponin” refers to all troponin isoforms expressed in cells of the heart and, preferably, the subendocardial cells. These isoforms are well characterized in the art as described, e.g., in Anderson 1995, Circulation Research, vol. 76, no. 4: 681-686 and Ferrieres 1998, Clinical Chemistry, 44: 487-493. Preferably, cardiac troponin refers to troponin T and/or troponin I, and, most preferably, to troponin T. It is to be understood that isoforms of troponins may be determined in the method of the present invention together, i.e. simultaneously or sequentially, or individually, i.e. without determining the other isoform at all. Amino acid sequences for human troponin T and human troponin I are disclosed in Anderson, loc cit and Ferrieres 1998, Clinical Chemistry, 44: 487-493.

The term “cardiac troponin” encompasses also variants of the aforementioned specific troponins, i.e., preferably, of troponin T or troponin I. Such variants have at least the same essential biological and immunological properties as the specific cardiac troponins. In particular, they share the same essential biological and immunological properties if they are detectable by the same specific assays referred to in this specification, e.g., by ELISA Assays using polyclonal or monoclonal antibodies specifically recognizing the said cardiac troponins. Moreover, it is to be understood that a variant as referred to in accordance with the present invention shall have an amino acid sequence which differs due to at least one amino acid substitution, deletion and/or addition wherein the amino acid sequence of the variant is still, preferably, at least 50%, 60%, 70%, 80%, 85%, 90%, 92%, 95%, 97%, 98%, or 99% identical with the amino sequence of the specific troponin. Variants may be allelic variants or any other species specific homologs, paralogs, or orthologs. Moreover, the variants referred to herein include fragments of the specific cardiac troponins or the aforementioned types of variants as long as these fragments have the essential immunological and biological properties as referred to above. Such fragments may be, e.g., degradation products of the troponins. Further included are variants which differ due to posttranslational modifications such as phosphorylation or myristylation.

Preferably, an amount of a cardiac troponin larger than the reference amount for said cardiac troponin indicates that said subject suffers from myocardial necrosis (and, thus, the myocardium of a subject comprises necrotic tissue, more preferably, physiologically significant amounts of necrotic tissue), whereas an amount of a cardiac troponin lower than the reference amount for said cardiac troponin indicates that said subject does not suffer from myocardial necrosis (and, thus, that the myocardium of a subject does not comprise necrotic tissue, more preferably does not comprises physiologically significant amounts of said tissue)

Thus, the reference amount defining a threshold amount for a cardiac troponin and, in particular, for troponin T as referred to in accordance with the present invention is, preferably, 15 pg/ml or 5 pg/ml, more preferably, 3 pg/ml, and, even more preferably, 2 pg/ml and, most preferably, 1 pg/ml.

Accordingly, an amount of H-FABP larger than the reference amount for H-FABP, and an amount of a cardiac troponin lower than the reference amount for said cardiac troponin, preferably, indicates that the myocardial hibernation is not accompanied by myocardial necrosis (preferably, not accompanied by a physiologically significant myocardial necrosis).

Moreover, an amount of H-FABP larger than the reference amount for H-FABP, and an amount of a cardiac troponin larger than reference amount for the cardiac troponin, preferably, indicates that a subject suffers from both myocardial hibernation and myocardial necrosis (and thus, that the myocardium comprises both hibernating and necrotic tissue, preferably physiologically significant amounts of the said tissue).

Moreover, an amount of H-FABP lower than the reference amount for H-FABP, and an amount of a cardiac troponin larger than the reference amount for said cardiac troponin indicates that a subject suffers from myocardial necrosis, but not from myocardial hibernation (and, thus, that the myocardium of a subject comprises necrotic tissue, but not hibernating tissue).

Moreover, an amount of H-FABP lower than the reference amount for H-FABP, and an amount of a cardiac troponin lower than the reference amount for said cardiac troponin indicates that a subject neither suffers from myocardial hibernation nor myocardial necrosis (and thus, that the myocardium neither comprises hibernating nor necrotic tissue).

It is to be understood that low amounts of a cardiac troponin, preferably indicate that there are, if at all, relatively low amounts (physiologically not significant amounts) of myocardial tissue that are non viable, whereas large amounts indicate large amounts (physiologically significant amounts, see elsewhere) of non-viable and, thus, necrotic tissue. Generally, the larger the amount of a cardiac troponin, the larger is the amount of non viable tissue in the myocardium.

It is to be understood, that in case of an amount of a cardiac troponin T lower than the reference amount, there may still necrotic tissue (or apoptotic tissue) present in the myocardium. However, these amounts are, preferably, considered as physiologically not significant (see also comments for H-FABP above).

In one preferred embodiment the method, preferably, further comprises determining the amount of a natriuretic peptide in a sample of said subject and comparing the amount of said natriuretic peptide to a reference amount (see elsewhere herein). The determination of a natriuretic peptide allows for assessing heart failure.

It is to be understood that the definitions and explanations of the terms made above and below apply mutatis mutandis for all embodiments/methods described in this specification and the accompanying claims.

Moreover, the present invention relates to a method for differentiating, in a subject, who preferably suffers from stable coronary artery disease and/or, preferably, comprises myocardial tissue with dysfunctional contractility, between (i) myocardial hibernation alone (ii) myocardial necrosis alone (iii) myocardial hibernation accompanied by a myocardial necrosis and (iv) a condition (preferably coronary artery disease) without myocardial hibernation and myocardial necrosis, comprising the steps,
a) determining the amount of Heart type fatty acid binding protein (H-FABP) in a sample of said subject,
b) determining the amount of a cardiac troponin in a sample of said subject, and
c) differentiating between (i) myocardial hibernation alone (ii) myocardial necrosis alone (iii) myocardial hibernation accompanied by a myocardial necrosis and (iv) a condition (preferably stable coronary artery disease) without myocardial hibernation and myocardial necrosis by comparing the amounts determined in step a) and b) with reference amounts.

The term “differentiating” as used herein means to distinguish between (i) myocardial hibernation (without necrosis) (ii) myocardial necrosis (without hibernation) (iii) myocardial hibernation accompanied by a myocardial necrosis and (iv) neither myocardial hibernation nor myocardial necrosis, in a subject. The term as used herein, preferably, includes differentially diagnosing/detecting myocardial hibernation, myocardial necrosis, or myocardial hibernation accompanied by myocardial necrosis. Preferably, the differentiation is carried out for a subject whose myocardium was shown to comprise regions of dysfunctional contractility (see above, which can be shown e.g. by echocardiography). Thus, the method, preferably, allows determining the underlying causes for dysfunctional contractility of the myocardium.

Preferred reference amounts are described elsewhere herein.

Preferably, (i) an amount of H-FABP larger than the reference amount for H-FABP and an amount of a cardiac troponin lower than the reference amount for said cardiac troponin indicates myocardial hibernation alone, and/or (ii) an amount of H-FABP lower than the reference amount for H-FABP and an amount of a cardiac troponin larger than the reference amount for said cardiac troponin indicates myocardial necrosis alone, and/or (iii) an amount of H-FABP larger than the reference amount for H-FABP and an amount of a cardiac troponin larger than the reference amount for said cardiac troponin indicates both myocardial hibernation and myocardial necrosis, and/or (iv) an amount of H-FABP lower than the reference amount for H-FABP and an amount of a cardiac troponin lower than the reference amount for said cardiac troponin indicates a condition without myocardial hibernation and myocardial necrosis.

Thus, the method of the present invention, preferably, allows differentiating between (i) the presence of hibernating tissue in the myocardium, but not of necrotic tissue (ii) the presence of necrotic tissue in the myocardium but not of hibernating tissue (iii) the presence of both hibernating and necrotic tissue in the myocardium and (iv) the absence of necrotic and hibernating tissue in the myocardium. It is to be understood that absence of both necrotic tissue and hibernating tissue (case iv), preferably can be an indicator for the presence of scars, and, thus, of fibrotic tissue, in the myocardium (caused, preferably, by a myocardial infarction).

Preferably, in case of (iii) and thus if both hibernating and necrotic tissue are present in the myocardium also the ratio of hibernating tissue to necrotic tissue (and vice versa) can be determined based on the ratio of the amount of H-FABP to the amount of a cardiac troponin.

Of course, small amounts of necrotic tissue may be present in case of (i) or (iv), however the person skilled in the art knows, that such small amounts are, preferably, physiologically not significant. Also low amounts of hibernating tissue that are, however, physiologically not significant may be present in case of (ii) or (iv). Amounts that are considered as being (physiologically) not significant are, preferably, less than 5%, more preferably, less than 1% and, most preferably less than 3% of the total myocardium.

Moreover, the present invention relates to a method for predicting the success of a cardiac intervention in a subject, comprising the steps
a) determining the amount of heart type fatty acid binding protein (H-FABP) in a sample of said subject,
b) comparing the amount as determined in step a) to a reference amount, and
c) predicting the success of a cardiac intervention.

The term “predicting” as used herein, preferably, relates to assessing the probability according to a cardiac intervention will be successful. The term “success” as used herein in the context of cardiac intervention, preferably, relates to the effectiveness of the particular cardiac intervention. More preferably, the success and, thus, the effectiveness relates to the improvement of the contractile function of the myocardium after a particular cardiac intervention, preferably, one month, two months and, more preferably, six months after said cardiac intervention. An improvement of contractile function of the myocardium within a range of 5 to 100%, 20 to 100% preferably, more than 40% and, most preferably within 40 to 100% is considered to be successful. Preferably, also an improvement of contractile function of the myocardium of at least 5% is considered to be successful. 1-low to determine the contractile function is well known in the art. Preferably, the contractile function can be determined by echocardiography, by MRT (magnetic resonance tomography), by determining markers of heart function such as BNP or NTpro-BNP or by determining the LVEF (left ventricular ejection fraction). Preferably, an intervention is successful if there is no need for urgent repeated intervention (such as PCI or surgical revascularization) within the one month, three months, six months after said intervention.

As will be understood by those skilled in the art, the aforementioned prediction is usually not intended to be correct for 100% of the subjects to be analyzed. The term, however, requires that the assessment will be valid for a statistically significant portion of the subjects to be analyzed. Whether a portion is statistically significant can be determined without further ado by the person skilled in the art using various well known statistic evaluation tools, e.g., determination of confidence intervals, p-value determination, Student's t-test, Mann-Whitney test, etc. Details are found in Dowdy and Wearden, Statistics for Research, John Wiley & Sons, New York 1983. Preferred confidence intervals are at least 90%, at least 95%, at least 97%, at least 98% or at least 99%. The p-values are, preferably, 0.1, 0.05, 0.01, 0.005, or 0.0001. Preferably, the probability envisaged by the present invention allows that the prediction will be correct for at least 60%, at least 70%, at least 80%, or at least 90% of the subjects of a given cohort.

The term “predicting the success of a cardiac intervention” as used herein means that the subject to be analyzed by the method of the present invention is allocated either into the group of subjects of a population that will show an normal improvement (average or less than the average improvement) of the contractile function of the myocardium, or into a group of subjects showing an elevated improvement (and thus a successful cardiac intervention) of the contractile function of the myocardium. An average improvement as referred to in accordance with the present invention, preferably means that the contractile function will improve within a range of 5 to 20%, and, most preferably within a range 5 to 15% with respect to a predictive window of six months after said cardiac invention. An elevated improvement as referred to in accordance with the present invention, preferably means that the contractile function will improve within a range of 20 to 100% preferably, more than 40% and, most preferably within 40 to 100% or even more with respect to a predictive window of six months after said cardiac invention.

Preferably, an amount of H-FABP in a sample of a subject larger than the reference amount indicates that a cardiac intervention will be successful/effective and, thus, improve the contractile function as indicated herein.

Preferably, an amount of H-FABP in a sample of a subject lower than the reference amount indicates that a cardiac intervention will not be successful/effective (less than average improvement of the contractile function as indicated herein) and/or only will be moderately successful/effective (and only will improve contractile function moderately, average improvement).

It has been found in the context of the present invention that H-FABP is a biomarker for hibernating myocardium. Since the function of hibernating myocytes can be restored (or at least improved) after restoring blood flow (e.g. after revascularization), the amount of H-FABP in a sample of a subject also is a valuable predictor the success of a cardiac intervention that restores the blood flow. Preferably, the larger the amount of H-FABP in a sample of a subject, the more hibernating tissue is present in the myocardium of said subject, and, thus, the more of the contractile function of the affected myocardium can be restored due to a cardiac intervention and, thus, the more successful is a cardiac intervention.

The definitions and explanations given herein above apply mutatis mutandis to the following:

Moreover, the present invention relates to a method for determining the success of a cardiac intervention in a subject who, preferably, suffers from stable coronary artery disease, comprising the steps of

determining, in a first sample (baseline sample) of said subject obtained prior to carrying out said cardiac intervention, the amount of H-FABP;
determining, in a second sample of said subject obtained after said cardiac intervention, the amount of H-FABP; and
comparing the amount of H-FABP as determined in step a) to the amount as determined in step b), wherein a decrease of the amount as determined in step b) compared with the amount as determined in step a) (thus the amount prior to said intervention) indicates that said cardiac intervention was successful.

The aforementioned determination whether a cardiac intervention was successful (and, thus, effective) or not is based on the comparison of the amount of H-FABP in a first sample obtained prior to said intervention (particular 1 hour, 1 day, 1 week or one month prior to said intervention) with the amount of H-FABP in a second sample obtained after said cardiac intervention. Said second sample is, preferably, obtained one month or more than one month, three months or more than three months, or more preferably, six months or more than six months after said intervention. However, it is also contemplated to obtain said second sample 12 hours, 24 hours, 2 days, three days, one week or two weeks after said intervention since it has been found in the context of the studies carried out in the context of the present invention that the amount of H-FABP is decreased—compared with the amount in a baseline sample (obtained prior to said intervention)—in a sample obtained 24 hours after said intervention has been carried out (in cases the intervention has been successful). Preferably, a decrease and more preferably a statistically significant decrease of the amount of H-FABP in said second sample compared to the amount in said first sample indicates that said cardiac intervention was successful, and thus that the contractile function of the myocardium has been sufficiently improved. Moreover, a decrease indicates that the oxygen supply to the myocardium is enhanced as a consequence of said intervention.

Preferably, the aforementioned method further comprises determining the amount of a natriuretic peptide, preferably of NT-proBNP in said first sample (in step a1) and said second sample (step b1) and comparing the amount of said natriuretic peptide as determined in first sample as determined in step a1) to the amount of said natriuretic peptide in said second sample as determined in step b1). Preferably, a decrease of the amount as determined in step b1) compared with the amount as determined in step a1) (thus the first sample) further indicates that said cardiac intervention was successful (if the same also applies for H-FABP and, optionally, a cardiac troponin).

Preferably, the aforementioned method further comprises determining the amount of a cardiac troponin in said first sample (a1′) and said second sample (step b1′) and comparing the amount of said cardiac troponin as determined in first sample as determined in step a1′) to the amount of said cardiac troponin in said second sample as determined in step b1′). Preferably, a decrease of the amount as determined in step b1′) compared with the amount as determined in step a1′) (thus the first sample) further indicates that said cardiac intervention was successful (if the same also applies for H-FABP and, optionally, a natriuretic peptide).

A definition for the term “natriuretic peptide” and the term “cardiac troponin” can be found elsewhere herein.

The terms “significant” and “statistically significant” are known to the person skilled in the art. Whether a decrease is statistically significant can be determined without further ado by the person skilled in the art using various well known statistic evaluation tools including those referred to herein.

Preferred significant decreases of the amount of H-FABP and a natriuretic peptide which have been found in the course of the invention to be associated with a successful and, thus, effective cardiac intervention are indicated herein below.

In the context of the aforementioned method, an decrease of the amount of H-FABP in the second sample compared to the amount in the first sample, preferably, of at least 15%, or of at least 25% more preferably of at least 35% and even, more preferably, of at least 50%, and most preferably of at least 60% is considered to be statistically significant and, thus, to be associated with a successful cardiac intervention.

Moreover, an decrease of the amount of H-FABP in the second sample compared to the amount in the first sample, preferably, of at least at least 500 pg/ml, more preferably of at least at least 1000 pg/ml, and even, more preferably, of at least 1500 pg/ml, and most preferably of at least 2000 pg/ml is considered to be statistically significant and, thus, to be associated with a successful cardiac intervention (in the context of the aforementioned method).

If in addition to the H-FABP also the amounts of a cardiac troponin and/or a natriuretic peptide are determined, the following applies:

Preferably, an decrease of the amount of a natriuretic peptide, preferably of NT-proBNP in the second sample compared to the amount in the first sample, preferably, of at least 25% more preferably of at least 35% and even, more preferably, of at least 50%, and most preferably of at least 60% is considered to be statistically significant and, thus, to be associated with a successful cardiac intervention.

Preferably, an decrease of the amount of a cardiac troponin, preferably of troponin T in the second sample compared to the amount in the first sample, preferably, of at least 25% more preferably of at least 35% and even, more preferably, of at least 50%, and most preferably of at least 60% is considered to be statistically significant and, thus, to be associated with a successful cardiac intervention.

The term “cardiac intervention”, preferably, encompasses those invasive treatment regimens intended to increase and/or restore blood flow in at least one coronary artery and, thus, to ameliorate and/or restore supply of the myocardium, preferably of hibernating myocardium, with oxygen. Thus, the term, preferably, relates to invasive treatment regimens allowing revascularization of the myocardium, preferably of the myocardial regions affected by hibernation. Preferably, blood supply of least one coronary artery, preferably of at least one stenosed coronary artery, more preferably of at least one stenosed coronary artery that supplies myocardial regions is restored by the said intervention.

Preferably, said cardiac intervention is a percutaneous coronary intervention. More preferably, said cardiac intervention is selected from the group consisting of percutaneous coronary angioplasty, percutaneous transluminal coronary balloon angioplasty, laser angioplasty, coronary stent implantation, bypass implantation and intraluminal techniques aiming to restore blood flow.

The term “success” as used herein in the context of cardiac intervention, preferably, relates to the effectiveness of the particular cardiac intervention. More preferably, the success and, thus, the effectiveness relates to the improvement of the contractile function of the myocardium after a particular cardiac intervention, preferably, one month, two months and, more preferably, six months after said cardiac intervention. An improvement of contractile function of the myocardium within a range of 5 to 100% 20 to 100% preferably, more than 40% and, most preferably within 40 to 100% or even more is, particularly, considered to be successful. Preferably, also an improvement of contractile function of the myocardium of at least 5% is considered to be successful. How to determine the contractile function is well known in the art and described herein above. Preferably, an intervention is successful if there is no need for repeated intervention (such as PCI or surgical revascularization) within two weeks, one month, three months, six months after said intervention. Preferably, an intervention is not successful if there is a need for repeated repeated intervention (such as PCI or surgical revascularization) within two weeks, one month, three months, six months after said intervention.

Advantageously, is has been found in the studies carried out in the context of the present invention that a) determining the amount of H-FABP in a first sample of a subject obtained prior to carrying out a cardiac intervention, b) determining the amount of H-FABP in a second sample obtained after said cardiac intervention, and comparing the amount of H-FABP in said first sample with the amount of H-FABP in said second sample allows for reliably determining the success of said cardiac intervention in said subject. Particularly, the cardiac intervention has been successful, if the amount of H-FABP in said second sample is decreased as compared to the amount of H-FABP in said first sample. Specifically, the amount of H-FABP was determined in samples of patients who underwent stent implantation. Samples were obtained shortly before the stent implantation was carried out (first sample) and 24 hours as well as 30 days after said stent implantation (second sample). A decreased amount of H-FABP in the 24-hours-sample and the 30-days-sample as compared to the first sample indicates that the stent implantation has been successful (see Examples).

Advantageously, it has been also shown, that the determination of the amount of a cardiac troponin allows for determining the success of a cardiac intervention (see Examples, e.g. patient 30).

The explanations and definitions given in the context with the aforementioned method apply mutatis mutandis to the following method (except stated otherwise).

Moreover, the present invention relates to a method for determining the success of a cardiac intervention in a subject who, preferably, suffers from stable coronary artery disease, comprising the steps of determining, in a first sample (baseline sample) of said subject obtained prior to carrying out said cardiac intervention, the amount of a cardiac troponin;

determining, in a second sample of said subject obtained after said cardiac intervention, the amount of a cardiac troponin; and
comparing the amount of a cardiac troponin as determined in step a) to the amount as determined in step b), wherein a decrease of the amount as determined in step b) compared with the amount as determined in step a) (thus the amount prior to said intervention) indicates that said cardiac intervention was successful.

The second sample is, preferably, obtained one month or more than one month, three months or more than three months, or more preferably, six months or more than six months after said intervention.

Preferably, an decrease of the amount of a cardiac troponin, preferably of troponin T in the second sample compared to the amount in the first sample, preferably, of at least 25% more preferably of at least 35% and even, more preferably, of at least 50%, and most preferably of at least 60% is considered to be statistically significant and, thus, to be associated with a successful cardiac intervention.

Moreover, an decrease of the amount of a cardiac troponin, preferably of troponin T, in the second sample compared to the amount in the first sample, preferably, of at least at least 10 pg/ml, more preferably of at least at least 50 pg/ml, and even, more preferably, of at least 75 pg/ml, and most preferably of at least 100 pg/ml is considered to be statistically significant and, thus, to be associated with a successful cardiac intervention (in the context of the aforementioned method).

Moreover, it has been shown that a few subjects in a cohort of subjects who underwent PCI had increased amounts of H-FABP after PCI (as compared to the amount of H-FABP in a sample obtained prior to said implantation). Particularly, it has been shown that increased amounts of H-FABP in a sample of subject that is obtained shortly after stent implantation indicate that the intervention has caused a cardiac complication, particularly an ACS, in said subject.

Accordingly, the present invention relates to a method for diagnosing a cardiac complication caused by a cardiac intervention in a subject, comprising

determining, in a first sample (baseline sample) of said subject, preferably, obtained prior to carrying out said cardiac intervention, the amount of H-FABP;
determining, in a second sample of said subject obtained after said cardiac intervention, the amount of H-FABP; and
comparing the amount of H-FABP as determined in step a) to the amount as determined in step b), wherein an increase of the amount as determined in step b) compared with the amount as determined in step a) indicates a cardiac complication caused by said cardiac intervention.

The definitions and explanation given herein for the other methods of the present invention, apply mutatis mutandis to the aforementioned method (except stated otherwise)

As will be understood by those skilled in the art, the diagnosis set forth above is usually not intended to be correct for 100% of the subjects to be diagnosed. The term, however, requires that a statistically significant portion of subjects can be diagnosed with respect to relevant disorder, risk or need. Whether a portion is statistically significant can be determined without further ado by the person skilled in the art using various well known statistic evaluation tools, e.g., determination of confidence intervals, p-value determination, Student's t-test, Mann-Whitney test, etc. Details are found in Dowdy and Wearden, Statistics for Research, John Wiley & Sons, New York 1983. Preferred confidence intervals are at least 90%, at least 95%, at least 97%, at least 98% or at least 99%. The p-values are, preferably, 0.1, 0.05, 0.01, 0.005, or 0.0001.

The term “subject” has been described elsewhere herein. As mentioned above, the subject shall suffer from stable coronary heart disease at the time at which the cardiac intervention is carried out (and/or at which the first sample is obtained). Thus, the subject shall not suffer from an ACS at the time at which the cardiac intervention is initiated. More preferably, said subject shall not have exhibited an acute cardiovascular event recently, preferably not within one week, not within two weeks, one month, six month or one year prior to carrying out cardiac intervention (or prior to obtaining the first sample).

The term “cardiac intervention”, preferably, encompasses those invasive treatment regimens intended to increase and/or restore blood flow in at least one coronary artery and, thus, to ameliorate and/or restore supply of the myocardium, preferably of hibernating myocardium, with oxygen. Thus, the term, preferably, relates to invasive treatment regimens allowing revascularization of the myocardium, preferably of the myocardial regions affected by hibernation. Preferably, blood supply of least one coronary artery, preferably of at least one stenosed coronary artery, more preferably of at least one stenosed coronary artery that supplies myocardial regions is restored by the said intervention.

Preferably, the cardiac intervention is a percutaneous coronary intervention. More preferably, said cardiac intervention is selected from the group consisting of percutaneous coronary angioplasty, percutaneous transluminal coronary balloon angioplasty, laser angioplasty, coronary stent implantation, bypass implantation and intraluminal techniques aiming to restore blood flow. The most preferred cardiac intervention in the context with the aforementioned method is coronary stent implantation.

The term “stent implantation” as used herein relates to introducing any kind of stent into a coronary artery. A stent is particularly understood as any kind of prosthesis which is capable of keeping a blood vessel open by mechanical strain against the wall of the vessel, particularly by expanding against the wall of the vessel. Prior to deployment, a stent is collapsed into a small diameter (e.g. as a folding grille). A stent can be self-expanding (e.g. a wall stent) or it can be expanded by additional means, e.g. a an inflatable balloon (e.g. Palmaz-stent). The stent can be made from any kind of material. Currently, most stents in clinical practice are made from metal. Typically, after expansion, the stent is affixed to the vessel wall by its own radial tension. Stents are most commonly inserted under fluoroscopic guidance or endoscopy, which are microinvasive procedures that are generally less invasive than conventional surgery. This makes stents suitable for patients with advanced disease or those for whom otherwise the risk of major surgery is high. In addition, general anesthesia is usually not required for stent insertion.

Moreover, in the context with the aforementioned method, the cardiac intervention may be any intervention which comprises coronary cathetherization.

The term “coronary catheterization” is known to the person skilled in the art. In the context of the invention, the term particularly relates to any kind of diagnostic or therapeutic intervention involving the introducing of a catheter into blood vessels belonging to the heart, particularly into the coronary arteries.

According to the invention, the term “coronary catheterization” is considered to include diagnostic (e.g. coronary angiography) as well as therapeutic catheterization (e.g. percutaneous coronary intervention (PCI)).

Particularly, diagnostic coronary catheterization as defined according to the invention allows to recognize e.g. occlusion, stenosis, restenosis, thrombosis or aneurysmal enlargement the coronary artery lumens, heart chamber size, heart muscle contraction performance and some aspects of heart valve function. Important internal heart and lung blood pressures, not measurable from outside the body, can be accurately measured during the test. The relevant problems that the test deals with most commonly occur as a result of advanced atherosclerosis, atheroma activity within the wall of the coronary arteries. Less frequently, other issues, valvular, heart muscle or arrhythmia issues are the primary focus of the test. Coronary artery luminal narrowing reduces the flow reserve for oxygenated blood to the heart, typically producing intermittent angina if very advanced; luminal occlusion usually produces a heart attack.

The term “coronary angiography” is known to the person skilled in the art. More particularly, it is a medical imaging technique in which a picture (e.g. an X-ray picture or magnetic resonance picture) is taken to visualize the inner opening of blood filled structures, e.g. arteries, veins and the heart chambers, particularly coronary arteries. The image of the blood vessels is called an angiograph, or more commonly, an angiogram. As blood has the same radiodensity as the surrounding tissues, a radiocontrast agent (which absorbs X-rays) may added to the blood to make angiography visualization by X-ray possible. A long, thin, flexible tube called a catheter is used to administer a contrast agent at the desired area to be visualized. The catheter is threaded into an artery e.g. in the groin or forearm, and the tip is advanced through the arterial system into one of the two major coronary arteries. The angiographic image is typically a shadow picture of the openings within the cardiovascular structures carrying blood (e.g. by means of the contrast agent within the blood). The images may be taken as still images or motion images. Motion images may also show the speed of blood (actually the speed of radiocontrast within the blood) traveling within the blood vessel.

Therapeutic coronary catheterization according to the invention relates to any kind of coronary catheterization for the purpose of treating a disorder or disease, including e.g. coronary angioplasty (particularly balloon dilatation) and stent implantation.

Therapeutic catheterization may be performed during a conventional surgery or microinvasively as PCI (percutaneous coronary intervention), which relates to any kind of angioplasty or stent implantation performed under microinvasive conditions. Microinvasive coronary angioplasty is also known as “transluminal coronary angioplasty”. The aforementioned method is particularly useful in the context of PCI.

The aforementioned method allows for diagnosing a cardiac complication before necrosis occurs. Consequently, the present invention also relates to determining a risk of suffering from necrosis due to a cardiac intervention since patients suffering from a cardiac complication have a high risk of necrosis. Therefore, early vigorous therapy or further diagnosis or monitoring can be initiated in order to avoid such necrosis. More particularly the term “before necrosis occurs” is understood as relating to a time before the level of a marker of necrosis, more particularly troponin T, has become significantly increased.

The aforementioned method provides very sensitive diagnostic information and the information can also be easily quantified. Therefore, the invention may also be used for quality assessment or quality monitoring of a cardiac intervention, e.g. to compare different methods of catheterization or stent implantation, to compare the performance of different clinics or departments, or in studies to develop new or improved methods of catheterization or subsequent treatment. Advantageously, the invention provides such information at a level of complications which are clinically not apparent or asymptomatic. Therefore, statistically significant information about increasing or reducing the number of cardiac complications can be obtained at lower patient numbers and lower numbers of clinically apparent or symptomatic events. Thus, such studies can be performed with less risk and/or fewer patients. The information is easily standardizable and can be easily or automatically analyzed by automated means, so that a routine quality assessment and/or alert system can be easily established.

The cardiac complication in the context with the aforementioned method, preferably, includes any complication which results in a reduced oxygen supply to the myocardium as compared to the oxygen supply to myocardium prior to the cardiac intervention and/or at the time at which the cardiac intervention is initiated. Thus, the term “cardiac complication” includes reduced oxygen supply to the myocardium as compared to the oxygen supply prior to the cardiac intervention and/or at the time at which the cardiac intervention is initiated. Moreover, said term includes reduced myocardial contractility as compared to the myocardial contractility prior to the cardiac intervention and/or at the time at which the cardiac intervention is initiated.

As set forth above, the cardiac complication shall be caused by the cardiac intervention, e.g. by damaging a heart vessel. Thus, a cardiac complication may be a damaged heart vessel. Moreover, in the context of aforementioned method rethrombosis and embolization are also considered as cardiac complication. The term “rethrombosis”, preferably, refers to a new formation of a new thrombus after said intervention. The term “embolization” is well known in the art (see, e.g., Colkesen et al. International Heart Journal Vol. 48 (2007), No. 2 pp. 129-136; or Rapp et. al Journal of Vascular Surgery, Volume 45, Issue 5, Pages 867-874). As used herein, the term “embolization”, preferably, refers to stent embolization.

In the context with the aforementioned method, the term cardiac complication, preferably, does not include cardiac arrhythmia or dysrhythmia.

Advantageously, the aforementioned method allows for diagnosing a cardiac complication even before the subject shows symptoms of said cardiac complication. Accordingly, the subject is, preferably, symptomless with respect to a cardiac complication when the second sample is obtained. Thus, the subject shall not feel uncomfortable and shall exhibit any signs of a cardiac complication, particularly of an ACS such as chest pain or other signs known to the person skilled in the art (when the second sample is obtained). The subject, however, may be pathological and suffer from a malfunction of his coronary vessels which may result in an acute cardiovascular event meaning the myocardium does not have the capacity to perform as required in order to ensure the necessary provision of blood to the subject's body. This may result in severe complications such as an acute cardiovascular event or even cardiac death.

Thus, also the risk for an acute cardiovascular event (ACS) can be diagnosed by carrying out the aforementioned method. Thus, the term “cardiac complication” also includes the risk for an ACS. ACS can be unstable angina pectoris (UAP) or myocardial infarction (MT). MI can be an ST-elevated MI or a non-ST-elevated MI. Specifically, a subject who has a cardiac complication (as diagnosed by the aforementioned method) is at risk of suffering from an ACS. Preferably, said subject is at risk of suffering from ACS with 48 hours, 24 hours, 12 hours, or, more preferably, within 6 hours after the second sample has been obtained. It is to be understood that not each subject who suffers from a cardiac complication, will suffer from an ACS (since the increased H-FABP amounts are reversible). However, a statistically significant number of subjects will suffer from an ACS.

The person skilled in the art understands what is meant if a cardiac complication is considered to be caused by a cardiac intervention. Particularly, a cardiac complication will generally considered to be caused by a cardiac intervention if it occurs within 12 hours, 1 day, 2 days, or three days after cardiac intervention. Alternatively or additionally, cardiac complication will generally be considered to have occurred due to (i.e. caused by) said cardiac intervention if the complication is causally related to cardiac intervention, whether directly or indirectly. Indications for such causal connection may include e.g. (i) a close time-relationship between catheterization and complication (see immediately above), and/or (ii) a connection of the kind of complication and catheterization (e.g. any additional myocardial ischemia or myocardial necrosis will generally be considered due to coronary catheterization as they are typical or frequent complications of catheterization), and/or (iii) a connection between the region of the cardiac tissue affected and the region in which catheterization was performed (e.g. myocardial ischemia or necrosis is found downstream of the blood flow of the investigated vessel or of a collateral which has become temporarily occluded during catheterization).

In the context with the aforementioned method, the “first sample” is particularly understood as a sample which is obtained in order to reflect the level of H-FABP prior to the cardiac intervention, during or at the end of the cardiac intervention. Therefore, it is clear to the person skilled in the art that the first sample is, preferably, obtained prior to said cardiac intervention, during said cardiac intervention or without undue delay after said intervention. Preferably, the “first sample” is taken shortly prior or immediately after said cardiac intervention. Preferably, the “first sample” within 12 hours prior to said intervention to 1 hour after said intervention, more preferably within 4 hours prior to said intervention to 30 minutes after said intervention, more preferably within 24 hours, or within 12 hours prior to said intervention. Most preferably, said first sample is obtained within 4 hours prior to said intervention.

In the context with the aforementioned method, the “second sample” is particularly understood as a sample which is obtained in order to reflect a change of the level of H-FABP as compared to the first sample. Preferably, the sample is obtained within 2 to 24, 3 to 24 hours, 3 to 12 hours, more preferably within 2 to 8 hours, 2 to 6 hours, 2 to 5 hours, even more preferably 4 to 8 hours, 4 to 6 hours, 4 to 5 hours after said cardiac intervention or most preferably approximately 4 hours after said cardiac intervention.

As set forth herein above, the terms “significant” and “statistically significant” are known to the person skilled in the art. Whether a decrease is statistically significant can be determined without further ado by the person skilled in the art using various well known statistic evaluation tools including those referred to herein.

Preferred significant increases of the amount of H-FABP which have been found in the course of the invention to be associated with a cardiac complication caused by a cardiac intervention are indicated herein below.

In the context with the aforementioned method, an increase of the amount or H-FABP in the second sample compared to the amount in the first sample, preferably, of at least 100%, or of at least 200% of at least 300% more preferably of at least 500% and even, more preferably, of at least 750%, and most preferably of at least 1000% is considered to be statistically significant and, thus, to be associated with a cardiac complication caused a cardiac intervention. It is to be understood that percentage increase which is considered to be significant depends on the amount of H-FABP in the first sample.

Moreover, an increase of the amount of H-FABP in the second sample compared to the amount in the first sample, preferably, of at least at least 3000 pg/ml, more preferably of at least at least 5000 pg/ml, and even, more preferably, of at least 10000 pg/ml, and most preferably of at least 15000 pg/ml is considered to be statistically significant and, thus, to be associated with a cardiac complication caused by a cardiac intervention (in the context of the aforementioned method).

The term “subject” is explained elsewhere herein. As mentioned above, the subject shall suffer from stable coronary heart disease at the time at which the cardiac intervention is initiated (and/or at which the first sample is obtained). Thus, the subject shall not suffer from an ACS at the time at which the cardiac intervention is carried out. More preferably, said subject shall not have exhibited an acute cardiovascular event recently, preferably not within one week, not within two weeks, one month, six month or one year prior to carrying out cardiac intervention (or prior to obtaining the first sample).

Advantageously, it has been found that a) determining, in a first sample (baseline sample) of a subject who suffers from stable coronary artery disease, said first sample being obtained prior to carrying out a cardiac intervention, the amount of H-FABP, and b) determining, in a second sample of said subject obtained after said cardiac intervention the amount of H-FABP; and comparing the amount of H-FABP as determined in step a) to the amount as determined in step b), allows for reliably diagnosing a cardiac complication caused by said intervention in said subject. Particularly, an increase of the amount as determined in step b) compared with the amount as determined in step a) indicates a cardiac complication caused by said cardiac intervention. Specifically, the amount of H-FABP has been determined in samples of subjects undergoing stent implantation: a first sample obtained shortly before the stent implantation was carried out and a second sample 4 hours after stent implantation. It was shown that patients who suffered from an ACS as a consequence of said intervention had significantly larger levels of H-FABP in said second sample as compared with said first sample. Thus, an increase of H-FABP indicates the presence of a cardiac complication after stent implantation. The aforementioned method present is advantageous, since it allows the diagnosis of cardiac complications caused by a cardiac intervention only a few hours after the intervention has been carried out. In patients with diagnosis of myocardial ischemia and/or high risk of necrosis, early vigorous therapy or further diagnosis or monitoring can be initiated in order to avoid further damage.

In the context of the present invention, it is also comtemplated to combine the method for diagnosing a cardiac complication caused by a cardiac intervention and the method for determining the success of a cardiac intervention in a subject (preferably suffering from stable coronary artery disease).

Accordingly, the present invention also envisages a method for monitoring a cardiac intervention, comprising the steps of
a) determining, in a first sample of said subject obtained prior to carrying out said cardiac intervention, the amount of H-FABP;
b) determining, in a second sample of said subject obtained after said cardiac intervention, the amount of H-FABP; and
c) comparing the amount of H-FABP as determined in step a) to the amount as determined in step b), wherein a decrease of the amount as determined in step b) compared with the amount as determined in step a) indicates that said cardiac intervention was successful, and wherein an increase of the amount as determined in step b) compared with the amount as determined in step a) indicates a cardiac complication caused by said cardiac intervention.

For specific explanations and definitions, see the explanations and definitions made in the context with the method for diagnosing a cardiac complication caused by a cardiac intervention and the method for determining the success of a cardiac intervention in a subject (herein above).

The definitions and explanations given herein above apply mutatis mutandis to the following (except stated otherwise):

Moreover, the present invention relates to a method for identifying a subject being susceptible to a cardiac intervention, said subject, preferably, suffering from stable coronary artery disease, comprising the steps
a) determining the amount of Heart type fatty acid binding protein (H-FABP) in a sample of said subject,
b) comparing the amount as determined in step a) to a reference amount, and
c) identifying a subject being susceptible to a cardiac intervention.

The term “identifying” as used herein, preferably, means assessing whether a subject will be susceptible to a cardiac intervention or not, and, thus, whether a subject will benefit from a cardiac intervention or not. It is to be understood that for a subject who is susceptible to a cardiac intervention the advantages of said therapy, preferably, will outweigh the disadvantages (particularly disadvantages caused by adverse side effect of a certain invasive treatment regimen, but also with respect to the costs). Also, for a subject who is not susceptible to a cardiac intervention, the disadvantages (particularly, with respect to adverse side effects but also with respect to the costs due to an over-treatment) of said intervention, preferably, will outweigh the advantages. Particularly, if a subject is not susceptible a certain cardiac intervention, costs that would result from on over-treatment will be saved and/or adverse side effects can be avoided if said subject is not subjected to a certain cardiac intervention.

As it will be understood by those skilled in the art, such an assessment is usually not intended to be correct for all (i.e. 100%) of the subjects to be identified. The term, however, requires that a statistically significant portion of subjects can be identified (e.g. a cohort in a cohort study). Whether a portion is statistically significant can be determined without further ado by the person skilled in the art using various well known statistic evaluation tools, e.g., determination of confidence intervals, p-value determination, Student's t-test, Mann-Whitney test etc. Details are found in Dowdy and Wearden, Statistics for Research, John Wiley & Sons, New York 1983. Preferred confidence intervals are at least 90%, at least 95%, at least 97%, at least 98% or at least 99%. The p-values are, preferably, 0.1, 0.05, 0.01, 0.005, or 0.0001. More preferably, at least 60%, at least 70%, at least 80% or at least 90% of the subjects of a population can be properly identified by the method of the present invention.

The term “cardiac intervention”, preferably, encompasses those invasive treatment regimens intended to increase and/or restore blood flow in at least one coronary artery and, thus, to ameliorate and/or restore supply of the myocardium, preferably of hibernating myocardium, with oxygen. Thus, the term, preferably, relates to invasive treatment regimens allowing revascularization of the myocardium, preferably of the myocardial regions affected by hibernation. Preferably, blood supply of least one coronary artery, preferably of at least one stenosed coronary artery, more preferably of at least one stenosed coronary artery that supplies myocardial regions is restored by the said intervention.

Preferably, said cardiac intervention is a percutaneous coronary intervention. More preferably, said cardiac intervention is selected from the group consisting of percutaneous coronary angioplasty, percutaneous transluminal coronary balloon angioplasty, laser angioplasty, coronary stent implantation, bypass implantation and intraluminal techniques aiming to restore blood flow.

A reference amount in the context with the aforementioned method may be derived (i) a subject being susceptible to cardiac intervention, and thus from a subject known to comprise hibernating myocardial tissue (or more preferably physiologically relevant amounts of hibernating tissue, see elsewhere herein) (ii) a subject not being susceptible to cardiac intervention, and thus from a subject known not to comprise hibernating myocardial tissue (or more preferably a subject known to comprise physiologically not significant amounts of hibernating myocardial tissue). Moreover, the reference amounts, preferably, define thresholds. Suitable reference amounts or threshold amounts may be determined by the method of the present invention from a reference sample to be analyzed together, i.e. simultaneously or subsequently, with the test sample. A preferred reference amount serving as a threshold may be derived from the upper limit of normal (ULN), i.e. the upper limit of the physiological amount to be found in a population of subjects (e.g. patients enrolled for a clinical trial). The ULN for a given population of subjects can be determined by various well known techniques. A suitable technique may be to determine the median of the population for the peptide or polypeptide amounts to be determined in the method of the present invention.

Preferred reference amounts are given herein above. A particularly preferred reference amount in the context of the aforementioned method for H-FABP as referred to in accordance with the present invention is 1500 pg/ml or 2000 pg/ml. Moreover, a further preferred reference amount is 1000 pg/ml.

Preferably, an amount of H-FABP larger than the reference amount in a sample of a subject indicates that said subject is susceptible to a cardiac intervention, and thus will benefit from a cardiac intervention. Preferably, an amount of H-FABP lower than the reference amount in a sample of a subject indicates that said subject is not susceptible to a cardiac intervention, and, thus, will not benefit from said intervention.

Preferably, the aforementioned method further comprises the determination of a cardiac troponin and comparing the, thus, determined amount to a reference amount for said cardiac troponin (for preferred reference amounts see herein elsewhere).

Preferably, the aforementioned method further comprises the determination of a natriuretic peptide and comparing the, thus, determined amount to a reference amount for said natriuretic peptide.

More preferably, the aforementioned method further comprises the determination of both a natriuretic peptide and a cardiac troponin and comparing the, thus, determined amounts to reference amounts for said natriuretic peptide and said cardiac troponin.

The term “natriuretic peptide” comprises Atrial Natriuretic Peptide (ANP)-type and Brain Natriuretic Peptide (BNP)-type peptides and variants thereof having the same predictive potential. Natriuretic peptides according to the present invention comprise ANP-type and BNP-type peptides and variants thereof (see e.g. Bonow, 1996, Circulation 93: 1946-1950). ANP-type peptides comprise pre-proANP, proANP, NT-proANP, and ANP. BNP-type peptides comprise pre-proBNP, proBNP, NT-proBNP, and BNP. The pre-pro peptide (134 amino acids in the case of pre-proBNP) comprises a short signal peptide, which is enzymatically cleaved off to release the pro peptide (108 amino acids in the case of proBNP). The pro peptide is further cleaved into an N-terminal pro peptide (NT-pro peptide, 76 amino acids in case of NT-proBNP) and the active hormone (32 amino acids in the case of BNP, 28 amino acids in the case of ANP).

Preferred natriuretic peptides according to the present invention are NT-proANP, ANP, NT-proBNP, BNP, and variants thereof. ANP and BNP are the active hormones and have a shorter half-life than their respective inactive counterparts, NT-proANP and NT-proBNP. BNP is metabolised in the blood, whereas NT-proBNP circulates in the blood as an intact molecule and as such is eliminated renally. The in-vivo half-life of NTproBNP is 120 min longer than that of BNP, which is 20 min (Smith 2000, J. Endocrinol. 167: 239-46). Preanalytics are more robust with NT-proBNP allowing easy transportation of the sample to a central laboratory (Mueller 2004, Clin Chem. Lab Med 42: 942-4). Blood samples can be stored at room temperature for several days or may be mailed or shipped without recovery loss. In contrast, storage of BNP for 48 hours at room temperature or at 4° Celsius leads to a concentration loss of at least 20% (Mueller loc. cit.; Wu 2004, Clin Chem 50: 867-73). Therefore, depending on the time-course or properties of interest, either measurement of the active or the inactive forms of the natriuretic peptide can be advantageous.

The most preferred natriuretic peptides according to the present invention are NT-proBNP or variants thereof. As briefly discussed above, the human NT-proBNP, as referred to in accordance with the present invention, is a polypeptide comprising, preferably, 76 amino acids in length corresponding to the N-terminal portion of the human NT-proBNP molecule. The structure of the human BNP and NT-proBNP has been described already in detail in the prior art, e.g., WO 02/089657, WO 02/083913 or Bonow loc. cit. Preferably, human NT-proBNP as used herein is human NT-proBNP as disclosed in EP 0 648 228 B1. These prior art documents are herewith incorporated by reference with respect to the specific sequences of NT-proBNP and variants thereof disclosed therein. The NT-proBNP referred to in accordance with the present invention further encompasses allelic and other variants of said specific sequence for human NT-proBNP discussed above. Specifically, envisaged are variant polypeptides which are on the amino acid level at least 60% identical, more preferably at least 70%, at least 80%, at least 90%, at least 95%, at least 98% or at least 99% identical, to human NT-proBNP. Substantially similar and also envisaged are proteolytic degradation products which are still recognized by the diagnostic means or by ligands directed against the respective full-length peptide. Also encompassed are variant polypeptides having amino acid deletions, substitutions, and/or additions compared to the amino acid sequence of human NT-proBNP as long as the said polypeptides have NT-proBNP properties. NT-proBNP properties as referred to herein are immunological and/or biological properties. Preferably, the NT-proBNP variants have immunological properties (i.e. epitope composition) comparable to those of NT-proBNP. Thus, the variants shall be recognizable by the aforementioned means or ligands used for determination of the amount of the natriuretic peptides. Biological and/or immunological NT-proBNP properties can be detected by the assay described in Karl et al. (Karl 1999, Scand J Clin Invest 59:177-181), Yeo et al. (Yeo 2003, Clinica Chimica Acta 338:107-115). Variants also include posttranslationally modified peptides such as glycosylated peptides. Further, a variant in accordance with the present invention is also a peptide or polypeptide which has been modified after collection of the sample, for example by covalent or non-covalent attachment of a label, particularly a radioactive or fluorescent label, to the peptide.

Preferably, a reference amount defining a threshold for a natriuretic peptide, more preferably, NT-proBNP as referred to in accordance with the present invention is, preferably, 300 pg/ml, more preferably, 500 pg/ml and, even more preferably, 1000 pg/ml, and most preferably 2000 pg/ml.

Preferably, an amount of H-FABP (and preferably of a cardiac troponin and/or a natriuretic peptide) in a sample of a subject larger than the reference amount indicates that said subject is susceptible to a cardiac intervention. Preferably, an amount of H-FABP (and preferably of a cardiac troponin and/or a natriuretic peptide) in a sample of a subject lower than the reference amount indicates that said subject is not susceptible to a cardiac intervention

The findings of the present invention are particularly advantageous, since the determination of H-FABP in a sample of a subject exhibit a good prognostic indication for the success of a cardiac intervention. Patients whose myocardium comprises hibernating tissue will benefit from a cardiac intervention that allows a revascularization. It is known in the art that, regarding hibernating myocardium, recovery of normal myocyte contractile function can be achieve upon revascularization. Thereby, mortality is significantly decreased (sec e.g. Alderman et al., Circulation 1983, 68:785-795). Thus, thanks to the present invention, a risk/success stratification can be easily performed before subjecting a patient to a cardiac intervention. In case the patient turns out to be not susceptible for a cardiac intervention (thus, a subject without myocardial hibernation (or only with low amounts of hibernating tissue), a time and/or cost intensive therapy can be avoided. Thus, besides preventing a subject from the adverse and severe side effects accompanying a cardiac intervention, the method of the present invention will be beneficial for the health system in that resources will be saved. It is to be understood that according to the method of the present invention described herein above and below, the amount of H-FABP or means for the determination thereof can be used for the manufacture of a diagnostic composition for identifying a subject being susceptible for a cardiac intervention. The specificity and sensitivity of the aforementioned assessment, i.e. whether a subject is susceptible to a cardiac intervention, and thus will benefit from a cardiac intervention can be even more increased, when also determining the amount of cardiac troponin and the amount of a natriuretic peptide in a sample of a subject and comparing the thus determined amounts to corresponding reference amounts. By determining the amount of a natriuretic peptide in addition to H-FABP, heart function can be assessed. Patients with low heart functionality as indicated by high levels of a natriuretic peptide and large amounts of hibernating myocardium will particularly benefit from a cardiac intervention and therefore are particularly susceptible thereto.

Furthermore, the present invention relates to kits and devices adapted to carry out the methods of the present invention.

Accordingly, the present invention relates to a device for diagnosing myocardial hibernation comprising
a) means for determining the amount of H-FABP in a sample of a subject, who, preferably, suffers from stable coronary artery disease, and
b) means for comparing the amount as determined by the means of a) with a reference amount, allowing diagnosis of myocardial hibernation.

The aforementioned device, preferably, further comprise a1) means for determining the amount of cardiac troponin (particularly, of troponin T; allowing diagnosis of myocardial necrosis) and/or means for determining the amount of a natriuretic peptide (particularly of NTproBNP), and b1) means for comparing the amounts as determined by the means of a1) with reference amounts.

Moreover, the present invention relates to a device for predicting the success of a cardiac intervention, said device comprising means
a) means for determining the amount of H-FABP in a sample of a subject, preferably, suffering from coronary artery disease, and
b) means for comparing the amount as determined by the means of a) with a reference amount, allowing prediction of the success of a cardiac intervention.

Moreover, the present invention relates to a device for differentiating, in a subject which, preferably, suffers from coronary artery disease, between (i) myocardial hibernation (ii) myocardial necrosis (iii) myocardial hibernation accompanied by a myocardial necrosis and (iv) a condition without myocardial hibernation and myocardial necrosis, comprising means
a) means for determining the amount of H-FABP and a cardiac troponin in a sample of a subject which, preferably, suffers from coronary artery disease, and
b) means for comparing the amounts as determined by the means of a) with reference amounts, allowing differentiating between (i), (ii), (iii) and (iv).

Moreover, the present invention relates to a device for identifying a subject being susceptible to cardiac intervention, comprising
a) means for determining the amount of H-FABP in a sample of a subject, preferably, suffering from coronary artery disease, and
b) means for comparing the amount as determined by the means of a) with a reference amount, allowing identifying a subject being susceptible to cardiac intervention.

The aforementioned device, preferably, further comprises a1) means for determining the amount of cardiac troponin (particularly, of troponin T) and/or means for determining the amount of a natriuretic peptide (particularly of NTproBNP), and b1) means for comparing the amounts as determined by the means of a1) with reference amounts.

Moreover, the present invention relates to a device for determining the success of a cardiac intervention for a subject, comprising
a) means for determining the amount of H-FABP in a first and a second sample of a subject which, preferably, suffers from coronary artery disease, and
b) means for comparing the amount in said first sample with the amount in said second sample as determined by the means of a) allowing determination of the success of a cardiac intervention.

The aforementioned device, preferably, further comprises a1) means for determining the amount of a natriuretic peptide and/or of a cardiac troponin (particularly, of troponin T) and in said first and said second sample and b1) means for comparing the amount as determined by the means of a1).

Moreover, the present invention relates to a device for determining the success of a cardiac intervention for a subject, comprising
a) means for determining the amount of a cardiac troponin, in a first and a second sample of a subject which, preferably, suffers from coronary artery disease, and
b) means for comparing the amount in said first sample with the amount in said second sample as determined by the means of a) allowing determination of the success of a cardiac intervention.

For explanations of the term “first sample” and “second sample” see remarks made in the context of the respective method.

Moreover, the present invention relates to a device diagnosing a cardiac complication caused by a cardiac intervention, comprising
a) means for determining the amount of H-FABP in a first and a second sample of a subject which, preferably, suffers from coronary artery disease, and
b) means for comparing the amount in said first sample with the amount in said second sample as determined by the means of a) allowing diagnosis of a cardiac complication caused by a cardiac intervention.

For explanations of the term “first sample” and “second sample” see remarks made in the context of the respective method.

The term “device” as used herein relates to a system of means comprising at least the aforementioned means operatively linked to each other as to allow the prediction. Preferred means for determining the amount of H-FABP (and a cardiac troponin and a natriuretic peptide) and means for carrying out the comparison are disclosed above in connection with the method of the invention. How to link the means in an operating manner will depend on the type of means included into the device. For example, where means for automatically determining the amount of the peptides are applied, the data obtained by said automatically operating means can be processed by, e.g., a computer program in order to obtain the desired results. Preferably, the means are comprised by a single device in such a case. Said device may accordingly include an analyzing unit for the measurement of the amount of the peptides or polypeptides in an applied sample and a computer unit for processing the resulting data for the evaluation. Alternatively, where means such as test stripes are used for determining the amount of the peptides or polypeptides, the means for comparison may comprise control stripes or tables allocating the determined amount to a reference amount. The test stripes are, preferably, coupled to a ligand which specifically binds to the peptides or polypeptides referred to herein. The strip or device, preferably, comprises means for detection of the binding of said peptides or polypeptides to the said ligand. Preferred means for detection are disclosed in connection with embodiments relating to the method of the invention above. In such a case, the means are operatively linked in that the user of the system brings together the result of the determination of the amount and the prognostic value thereof due to the instructions and interpretations given in a manual. The means may appear as separate devices in such an embodiment and are, preferably, packaged together as a kit. The person skilled in the art will realize how to link the means without further ado. Preferred devices are those which can be applied without the particular knowledge of a specialized clinician, e.g., test stripes or electronic devices which merely require loading with a sample. The results may be given as output of raw data which need interpretation by the clinician. Preferably, the output of the device is, however, processed, i.e. evaluated, raw data the interpretation of which does not require a clinician. Further preferred devices comprise the analyzing units/devices (e.g., biosensors, arrays, solid supports coupled to ligands specifically recognizing the biomarkers, Plasmon surface resonance devices, NMR spectrometers, mass-spectrometers etc.) or evaluation units/devices referred to above in accordance with the method of the invention.

Moreover, the present invention relates to a kit adapted to carry out the method of the present invention, said kit comprising instructions to carry out the said method, and
a) means for determining the amount of H-FABP in a sample of a subject, and
b) means for comparing the amount as determined by the means of a) with a reference amount, allowing diagnosis of myocardial hibernation.

The aforementioned kit, preferably, further comprises a1) means for determining the amount of cardiac troponin (particularly, of troponin T) and/or means for determining the amount of a natriuretic peptide (particularly of NTproBNP), and b1) means for comparing the amounts as determined by the means of a1) with reference amounts.

Moreover, the present invention relates to a kit adapted to carry out the method of the present invention, said kit comprising instructions to carry out the said method, and
a) means for determining the amount of H-FABP in a sample of a subject, and
b) means for comparing the amount as determined by the means of a) with a reference amount, allowing predicting the success of a cardiac intervention.

Moreover, the present invention relates to a kit adapted to carry out the method of the present invention, said kit comprising instructions to carry out the said method, and
a) means for determining the amount of H-FABP in a first and a second sample of a subject which, preferably, suffers from coronary artery disease, and
b) means for comparing the amount in said first sample with the amount in said second sample as determined by the means of a) allowing determination of the success of a cardiac intervention.

The aforementioned kit, preferably, further comprises a1) means for determining the amount of a natriuretic peptide and/or of a cardiac troponin (particularly, of troponin T) and in said first and said second sample and b1) means for comparing the amount as determined by the means of a1).

Moreover, the present invention relates to a kit adapted to carry out the method of the present invention, said kit comprising instructions to carry out the said method, and
a) means for determining the amount of a cardiac troponin in a first and a second sample of a subject which, preferably, suffers from coronary artery disease, and
b) means for comparing the amount in said first sample with the amount in said second sample as determined by the means of a) allowing determination of the success of a cardiac intervention.

Moreover, the present invention relates to kit for diagnosis of a cardiac complication caused by a cardiac intervention, comprising instructions to carry out the said diagnosis
a) means for determining the amount of H-FABP in a first and a second sample of a subject which, preferably, suffers from coronary artery disease, and
b) means for comparing the amount in said first sample with the amount in said second sample as determined by the means of a) allowing diagnosis of a cardiac complication caused by a cardiac intervention.

Moreover, the present invention relates to a kit for differentiating, in a subject which, preferably, suffers from coronary artery disease, between (i) myocardial hibernation (ii) myocardial necrosis (iii) myocardial hibernation accompanied by a myocardial necrosis and (iv) a condition without myocardial hibernation and myocardial necrosis, comprising instructions to carry out the said method, and means
a) means for determining the amount of H-FABP and a cardiac troponin in a sample of a subject which, preferably, suffers from coronary artery disease, and
b) means for comparing the amounts as determined by the means of a) with reference amounts, allowing differentiating between (i), (ii), (iii) and (iv).

Moreover, the present invention relates to a kit adapted identify a subject being, susceptible to a cardiac intervention, said kit comprising instructions to carry out the said method, and
a) means for determining the amount of H-FABP in a sample of a subject, preferably, suffering from coronary artery disease, and
b) means for comparing the amount as determined by the means of a) with a reference amount, allowing identifying a subject being susceptible to cardiac intervention.

The aforementioned kit, preferably, further comprises a1) means for determining the amount of cardiac troponin (particularly, of troponin T) and means for determining the amount of a natriuretic peptide (particularly of NTproBNP), and b1) means for comparing the amounts as determined by the means of a1) with reference amounts.

The term “kit” as used herein refers to a collection of the aforementioned means, preferably, provided separately or within a single container. The components of the kit may be comprised by separate vials (i.e. as a kit of separate parts) or provided in a single vial. Moreover, it is to be understood that the kit of the present invention is to be used for practising the methods referred to herein above. It is, preferably, envisaged that all components are provided in a ready-to-use manner for practising the methods referred to above. Further, the kit preferably contains instructions for carrying out the said methods. The instructions can be provided by a user's manual in paper- or electronic form. For example, the manual may comprise instructions for interpreting the results obtained when carrying out the aforementioned methods using the kit of the present invention.

Furthermore, the present invention relates to the use of H-FABP (preferably, in a sample of a subject), as a marker for hibernating myocardial tissue and, thus, to the use of H-FABP and for diagnosing/detecting hibernation myocardial tissue. Also, the present invention relates to the use of H-FABP (and optionally a cardiac troponin and/or a natriuretic peptide), preferably, in a sample of a subject for identifying a subject being susceptible to a cardiac intervention.

Also envisaged by the present invention is the use of H-FABP in a sample of a subject (and optionally a cardiac troponin) for predicting the success of a cardiac intervention as well as the use of H-FABP (and optionally a cardiac troponin and/or a natriuretic peptide), preferably, in a sample of a subject for determining the success of a cardiac intervention.

Also envisaged by the present invention is the use of a cardiac troponin in a sample of a patient for determining the success of a cardiac intervention.

Moreover, the present invention relates to the use of H-FABP (preferably, in a first and second sample of a subject undergoing a cardiac intervention) for diagnosing a cardiac complication caused by a cardiac intervention.

Moreover, the present invention relates to the use H-FABP and a cardiac troponin (preferably, in a sample of a subject) for differentiating between hibernating myocardial tissue and necrotic myocardial tissue and, thus, for differentiating between myocardial hibernation and myocardial necrosis.

All references cited in this specification are herewith incorporated by reference with respect to their entire disclosure content and the disclosure content specifically mentioned in this specification.

The following Examples shall merely illustrate the invention. They shall not be construed, whatsoever, to limit the scope of the invention.

### Example 1

### H-FABP and Troponin T in Patients with Stable Coronary Heart Disease

H-FABP and sensitive troponin T were determined in blood samples of a total of 234 patients with stable coronary heart disease. The patients did not apparently suffer from an acute coronary event. H-FABP was determined as specified above. Troponin T was determined by a highly-sensitive troponin T test with a detection limit of 0.002 ng/ml. Patients were subjected to a detailed cardiologic investigation including echocardiography and coronary angioplasty. The coronary heart disease was subclassified into 1-, 2- or 3-vessel diseases, whereby stenosis of more than 50% should occur per vessel. The results are shown in the following table. H-FABP was also determined in subject with no apparently cardiac complication.

Assays: troponin T was determined by using a highly-sensitive TnT assay with a detection limit of 0.002 ng/ml, and H-FABP was determined by using a H-FABP ELISA Test Kit (HBT ELISA Test kit for human heart type fatty acid binding protein; HyCult Biotechnology, Uden, The Netherlands).

TABLE 1
Amounts/levels of troponin T and H-FABP in patients
with stable coronary heart disease.

| | H-FABP [pg/ml] N = 234 | | | |
|---|---|---|---|---|
| | 1. Quartil | 2. Quartil | 3. Quartil | 4. Quartil |
| N | 60 | 55 | 59 | 60 |
| Median H-FABP pg/ml | 1132.1 | 1870.0 | 2636.5 | 4086.8 |
| Range | 0-1550 | 1565-2208 | 2223-3337 | 3357-46370 |
| Age, median | 61 | 64 | 66 | 71 |
| Coronary artery disease | | | | |
| 1-vessel disease | 22 | 9 | 10 | 10 |
| 2-vessel disease | 15 | 10 | 19 | 16 |
| 3-vessel disease | 15 | 25 | 23 | 29 |
| Median NT-proBNP pg/ml | 123.0 | 163.6 | 354.8 | 835.3 |
| Range | 11.2-35802 | 5.0-5514 | 6.9-13583 | 29.6-14953 |
| Median Hs-TnT ng/ml | 0.003 | 0.005 | 0.007 | 0.014 |
| Range | 0.0-0.113 | 0.0-0.553 | 0.0-0.600 | 0.0-0.708 |

H-FABP increases with the number of vessels that are affected by CAD indicating that H-FABP is a marker for hibernating myocardium. In subjects without an apparent cardiac dysfunction the amounts for H-FABP were low (e.g. Median in a cohort of 50 individuals 990 pg/ml)

### Example 2

H-FABP, troponin T and NT-proBNP are determined in a serum sample of 53 year old male patient (NYHA class II) with known coronary artery disease (H-FABP 3100 pg/ml, troponin T 4 pg/ml, NT-proBNP 490 pg/ml). The patient is examined by echocardiography indicating that the posterior myocardial wall comprises regions that are not contractile. Coronary angiography indicates 80% stenosis in an artery supplying the non contractile regions. Balloon dilatation is carried out in order restore the blood flow in the affected artery. Three months after the intervention H-FABP, troponin T and NT-proBNP are determined again (H-FABP 1230 pg/ml, troponin T 3 pg/ml, NT-proBNP 280 pg/ml). Echocardiography shows that there are no visible regions in the myocardium anymore having a reduced contractility.

### Example 3

The levels of troponin T and H-FABP were determined in 30 patients which underwent stent implantation. Measurements were carried out in samples obtained at various time points: 0 hours (baseline), four hours after stent implantation, 24 hours after stent implantation and 30 days after stent implantation (not for all patients were all samples available).

H-FABP in Samples Obtained 4 Hours after Stent Implantation

Table 2 shows the baseline level of troponin T and H-FABP as well as the H-FABP level in the 4 h sample and the troponin T level in the 24 h sample of 13 patients. Two patients (patient 13 and patient 43) suffered from an ACS caused by stent implantation (as indicated by amounts of serum troponin T larger than 0.1 ng/ml in the 24 h sample). These patients had significantly increased amounts of H-FABP in the four hour sample and of troponin T (TNT) in the 24 h sample. Patients 23, 25, 28, 31, 40, 44, 49, 51 and 53 did not suffer from a cardiac complication.

TABLE 2

| | prae OP | | | prae OP | | |
|---|---|---|---|---|---|---|
| | 0 h | post OP 24 h | | 0 h | post OP 4 h | |
| | Serum | | | | | |
| | hS TNT | hS TNT | | h_H-FABP | h_H-FABP | |
| patient ID | pg/ml | pg/ml | % Change | pg/ml | Pg/ml | % Change |
| 0013 | 71.32 | 1375.91 | 1929% | <1000.00 | 66786.24 | 6679% |
| 0025 | 28.36 | 27.10 | 96% | <1000.00 | 1359.23 | 136% |
| 0031 | 8.80 | 8.45 | 96% | <1000.00 | 1359.23 | 136% |
| 0040 | 3.00 | 3.00 | 100% | <1000.00 | 1905.07 | 191% |
| 0043 | 6.96 | 377.25 | 5423% | <1000.00 | 17120.11 | 1712% |
| 0051 | 5.86 | 11.52 | 196% | <1000.00 | 2010.47 | 201% |
| 0061 | 51.89 | 79.61 | 153% | <1000.00 | 3115.42 | 312% |
| 02-0023 | 50.64 | 31.14 | 61% | <1000.00 | <1000.00 | |
| 02-0028 | 5.73 | 7.68 | 134% | <1000.00 | <1000.00 | |
| 02-0044 | 3.23 | 28.29 | 877% | <1000.00 | <1000.00 | |
| 02-0059 | 16.60 | 9.79 | 59% | <1000.00 | <1000.00 | |

Thus, the determination of H-FABP allows for diagnosing a cardiac complication caused by a cardiac intervention.

Interestingly, some patients shown in table 2 had very low levels of H-FABP (below the detection limit of the assay, 1000 pg/ml) prior to the intervention. This indicates that the myocardium of these patient comprised only low amounts of hibernating tissue. Thus, the stent implantation has put those patients at risk of a cardiac complication without significantly improving myocardial function. By determining the amount of H-FABP, these patients could have been easily identified as not being susceptible to a cardiac intervention.

### H-FABP in Samples Obtained 24 Hours After Stent Implantation

Table 3 shows the amounts of H-FABP and troponin T in serum samples of various patients obtained prior to carrying out the stent implantation (0 h sample) and in a sample obtained 24 hours after stent implantation.

| | Prae OP | | | | |
|---|---|---|---|---|---|
| | (baseline) | | | | |
| Stud-PID/ | h_H-FABP | hS TNT | Post OP | h_H-FABP | hS TNT |
| PatientenID | pg/ml | pg/ml | 24 h | pg/ml | pg/ml |
| 02-0025 | <1000.00 | 28.36 | | <1000.00 | 27.10 |
| 02-0030 | 2523.55 | 20.39 | | <1000.00 | 18.89 |
| 02-0042 | <1000.00 | 13.17 | | 67405.54 | 2705.59 |
| 02-0044 | <1000.00 | 3.23 | | <1000.00 | 28.29 |
| 02-0045 | 1245.32 | 150.65 | | <1000.00 | 121.56 |
| 02-0046 | 1070.48 | 17.82 | | <1000.00 | 33.56 |
| 02-0047 | 3260.19 | 54.24 | | <1000.00 | 29.15 |
| 02-0049 | 3018.26 | 33.13 | | 1206.02 | 32.36 |
| 02-0051 | <1000.00 | 5.86 | | <1000.00 | 11.52 |
| 02-0053 | 2422.58 | 17.95 | | <1000.00 | 19.37 |
| 02-0055 | 7875.69 | 260.98 | | 1382.15 | 282.20 |
| 02-0056 | 1415.50 | 11.16 | | <1000.00 | 22.60 |
| 02-0057 | 1245.32 | 66.10 | | <1000.00 | 33.50 |
| 02-0058 | 4611.83 | 6.46 | | 2959.79 | 26.32 |
| 02-0059 | <1000.00 | 16.60 | | <1000.00 | 9.79 |
| 02-0060 | 2062.79 | 5.21 | | <1000.00 | 11.04 |
| 02-0061 | <1000.00 | 51.89 | | <1000.00 | 79.61 |
| 02-0062 | 4061.69 | 21.43 | | <1000.00 | 17.81 |
| 02-0064 | <1000.00 | 7.74 | | <1000.00 | 20.94 |
| 02-0065 | 1471.33 | 46.49 | | <1000.00 | 49.58 |
| 02-0067 | 1187.60 | 163.57 | | <1000.00 | 146.19 |

The amount of H-FABP in patients 30, 45, 47, 49, 53, 56, 60 and 66 in the second sample (24 h) was significantly lower than the amount of H-FABP in the first sample (0 h) indicating that the blood and oxygen supply to the myocardium is increased. Thus, the intervention has been successful. Patient 42 had significantly increased amounts of H-FABP in the second sample as compared with the first sample indicating a cardiac complication caused by the cardiac intervention.

H-FABP 30 Days after Stent Implantation. A Marker for Determining the Success of a Cardiac Intervention

In patient #30H-FABP was also determined in a sample obtained 30 days after stent implantation. Even after 30 days the level of H-FABP was lower than the detection limit of the H-FABP assay (<1000 pg/ml) indicating that the cardiac intervention has been successful (H-FABP at baseline 2523.55 pg/ml.

Troponin T 30 Days after Stent Implantation. A Marker for Determining the Success of a Cardiac Intervention

In the same patient (patient #30), also the amount of troponin T was determined in the baseline sample (0 h) and in the sample obtained 30 days after stent implantation. Compared with the baseline sample (serum concentration of troponin T 20.39 pg/ml), the concentration of in the sample obtained after 30 days was significantly decreased (7.23 pg/ml).

What is claimed is:

1. A method for diagnosing myocardial hibernation in a subject comprising the steps of
determining an amount of heart-type fatty acid binding protein (H-FABP) in a sample from the subject, and
comparing the amount of H-FABP determined to a reference amount of H-FABP, wherein an amount of H-FABP in the sample larger than the reference amount indicates that the subject suffers from myocardial hibernation and an amount of H-FABP lower than the reference amount indicates that the subject does not suffer from myocardial hibernation.

2. The method of claim 1, wherein the subject suffers from stable coronary artery disease and/or comprises myocardial tissue with dysfunctional contractility.

3. The method of claim 1 wherein the reference amount for H-FABP is 3000 pg/ml.

4. The method of claim 1 further comprising determining an amount of a cardiac troponin in a sample from the subject and comparing the amount of cardiac troponin determined to a reference amount for the cardiac troponin.

5. The method of claim 4, wherein the cardiac troponin is troponin T and wherein the reference amount for the cardiac troponin is 3 pg/ml.

6. A method for differentiating in a subject between (i) myocardial hibernation, (ii) myocardial necrosis, (iii) myocardial hibernation accompanied by a myocardial necrosis, and (iv) a condition without myocardial hibernation and myocardial necrosis, the method comprising the steps of
determining an amount of heart-type fatty acid binding protein (H-FABP) in a sample from the subject,
determining an amount of a cardiac troponin in a sample from the subject, and
differentiating between (i) myocardial hibernation, (ii) myocardial necrosis, (iii) myocardial hibernation accompanied by a myocardial necrosis, and (iv) a condition without myocardial hibernation and myocardial necrosis by comparing the amounts of H-FABP and cardiac troponin determined with reference amounts of H-FABP and cardiac troponin, wherein (i) an amount of H-FABP larger than the reference amount for H-FABP and an amount of the cardiac troponin lower than the reference amount for the cardiac troponin indicates myocardial hibernation; (ii) an amount of H-FABP lower than the reference amount for H-FABP and an amount of the cardiac troponin larger than the reference amount for the cardiac troponin indicates myocardial necrosis; (iii) an amount of H-FABP larger than the reference amount for H-FABP and an amount of the cardiac troponin larger than the reference amount for the cardiac troponin indicates myocardial hibernation accompanied by a myocardial necrosis; and (iv) an amount of H-FABP lower than the reference amount for H-FABP and an amount of the cardiac troponin lower than the reference amount for the cardiac troponin indicates a condition without myocardial hibernation and myocardial necrosis.

7. The method of claim 6, wherein the subject suffers from stable coronary artery disease and/or comprises myocardial tissue with dysfunctional contractility.

8. A method for identifying a subject being susceptible to a cardiac intervention, wherein the subject suffers from stable coronary artery disease, the method comprising the steps of
determining an amount of heart-type fatty acid binding protein (H-FABP) in a sample from the subject,
comparing the amount of H-FABP determined to a reference amount of H-FABP, wherein an amount of H-FABP in the sample larger than the reference amount indicates that the subject is susceptible to a cardiac intervention and an amount of H-FABP lower than the reference amount indicates that the subject is not susceptible to a cardiac intervention.

9. The method of claim 8, wherein the reference amount is 1500 pg/ml.

10. The method of claim 8, further comprising determining an amount of a cardiac troponin and/or a natriuretic peptide and comparing the determined amount(s) to reference amounts for the cardiac troponin and/or the natriuretic peptide, wherein amounts of the cardiac troponin and/or the natriuretic peptide in the sample larger than the reference amounts indicate that the subject is susceptible to a cardiac intervention and amounts of the cardiac troponin and/or the natriuretic peptide in the sample lower than the reference amounts indicate that the subject is not susceptible to a cardiac intervention.

11. The method of claim 8, wherein the cardiac intervention is an invasive treatment regimen allowing revascularization of the myocardium.

12. A method for predicting the success of a cardiac intervention in a subject suffering from stable coronary artery disease, the method comprising the steps of
determining an amount of heart-type fatty acid binding protein (H-FABP) in a sample from the subject,
comparing the amount of H-FABP determined to a reference amount of H-FABP and predicting the success of a cardiac intervention.

13. A method for determining success of a cardiac intervention in a subject suffering from stable coronary artery disease comprising the steps of
determining in a first sample from the subject a first amount of heart-type fatty acid binding protein (H-FABP), wherein the first sample is obtained prior to carrying out the cardiac intervention,
determining in a second sample from the subject a second amount of H-FABP, wherein the second sample is obtained after the cardiac intervention, and
comparing the first amount of H-FABP to the second amount, wherein a decrease of the second amount compared with the first amount indicates that the cardiac intervention was successful.

14. The method of claim 13, further comprising determining an amount of a natriuretic peptide and/or of a cardiac troponin in the first and the second sample and comparing the amount of the natriuretic peptide and/or of a cardiac troponin in the first sample to the amount of the natriuretic peptide and/or of a cardiac troponin in the second sample.

15. A method for determining the success of a cardiac intervention in a subject suffering from stable coronary artery disease comprising the steps of
determining, in a first sample from the subject, a first amount of a cardiac troponin, wherein the first sample is obtained prior to carrying out the cardiac intervention,
determining, in a second sample from the subject, a second amount of a cardiac troponin, wherein the second sample is obtained after the cardiac intervention, and
comparing the first amount of the cardiac troponin to the second amount, wherein a decrease of the second amount compared with the first amount indicates that the cardiac intervention was successful.

16. A method for diagnosing a cardiac complication caused by a cardiac intervention in a subject, comprising
determining, in a first sample (baseline sample) from the subject obtained prior to carrying out the cardiac intervention, a first amount of heart-type fatty acid binding protein (H-FABP),
determining, in a second sample from the subject obtained after the cardiac intervention, a second amount of H-FABP, and
comparing the first amount of H-FABP to the second amount, wherein an increase of the second amount compared with the first amount indicates a cardiac complication caused by the cardiac intervention.

17. The method of claim 16, wherein the first sample is obtained within 24 hours prior to the intervention.

18. The method of claim 16, wherein the second sample is obtained within 4 to 8 hours after the intervention has been carried out.

19. The method of claim 16, wherein an increase of at least 3000 pg/ml of H-FABP in the second sample as compared with the first sample indicates a cardiac complication.

20. A device for diagnosing myocardial hibernation according to the method of claim 1 comprising
means for determining an amount of H-FABP in a sample of a subject, and
means for comparing the amount of H-FABP determined with a reference amount of H-FABP.

21. A kit adapted to carry out the method of claim 1, the kit comprising
instructions to carry out the method,
means for determining an amount of H-FABP in a sample of a subject, and
means for comparing the amount determined with a reference amount.
